(19) United States
(12) Patent Application Publication
(10) Pub. No.: US 2023/0090294 A1
(43) Pub. Date: Mar. 23, 2023

(54) Polyelectrolyte Single Crystal for Proton Conductivity

(71) Applicants: Northwestern University, Evanston, IL (US); KING ABDULAZIZ CITY FOR SCINCE AND TECHNOLOGY (KACST), Riyadh (SA)

(72) Inventors: Qing-Hui Guo, Evanston, IL (US); James Fraser Stoddart, Evanston, IL (US)

(21) Appl. No.: 17/760,040

(22) PCT Filed: Feb. 3, 2021
(86) PCT No.: PCT/US2021/016427

§ 371 Date: Aug. 3, 2022

Related U.S. Application Data
(60) Provisional application No. 62/969,425, filed on Feb. 3, 2020.

(51) Int. Cl. H01M 8/1072; H01M 8/103

(52) U.S. Cl. CPC H01M 8/1072; H01M 8/103; H01M 2300/0085; H01M 2300/0082

(57) ABSTRACT

Disclosed herein are supramolecular compositions, polyelectrolyte polymers, and polyelectrolyte crystals for proton conductivity prepared from organic ions, the organic ion comprising a molecular hub and arms extending therefrom, wherein the arms comprise a polymerizable moiety. Also disclosed herein are method of making and using the compositions, polymers, and crystals described herein.

### CROSS-REFERENCE TO RELATED APPLICATION

This application claims benefit of priority to U.S. Patent Application No. 62/969,425, filed Feb. 3, 2020, the contents of which is incorporated by reference in its entirety.

### BACKGROUND OF THE INVENTION

Polyelectrolytes have attracted considerable attention in the field of all-solid-state batteries and fuel cells. The topochemical synthesis of ionic polymeric or polyelectrolyte single crystals (PSCs), however, remains elusive and particularly challenging because of the strong Coulombic repulsive interactions which operate during the self-assembly of a pair of cationic or anionic appendages from two ionic monomers.

### BRIEF SUMMARY OF THE INVENTION

Disclosed herein are supramolecular compositions, polyelectrolyte polymers, and polyelectrolyte crystals for proton conductivity. Also disclosed herein are method of making and using the compositions, polymers, and crystals described herein.

One aspect of the invention is a supramolecular composition. The supramolecular composition may comprise an ordered arrangement of a plurality of organic ions and a plurality of counterions. The organic ions comprising a molecular hub and arms extending therefrom, wherein the arms comprise a polymerizable moiety.

Another aspect of the invention is a polyelectrolyte polymer molecule. The polymer may comprise a chain formed from the polymerization of a plurality of organic ions. Each organic ion may comprise a molecular hub and arms extending therefrom, wherein the arms comprise a polymerizable moiety.

Another aspect of the invention is a polyelectrolyte crystal. The crystal may comprise a plurality of the polymer molecules described herein and further comprising a plurality of counterions.

Another aspect of the invention is a method of making any of the polymers or crystals described herein. The method may comprise providing any of the supramolecular compositions described herein, irradiating the composition for an effective time with an effective frequency to induce polymerization of the polymerizable moiety, thereby forming the polyelectrolyte polymer or the polyelectrolyte crystal.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIGS. 1A-1E illustrate the design concept and strategy for the synthesis of single crystalline polycationic polymer. (FIG. 1A) Schematic diagram for the preparation of polymer crystals from the crystallization of preorganized monomers, followed by the topochemical photopolymerization. (FIG. 1B) The unfavorable self-repulsive interaction in a parallel manner. (FIG. 1C) The self-complementary interactions facilitate the proximity of two reactive sites in an anti-parallel manner. (FIG. 1D) Structural formula of the monomer. (FIG. 1E) Scheme for photopolymerization.

FIGS. 2A-2F illustrates Single-crystal (super)structures of monomer, intermediate and polymer. (FIG. 2A) The preorganized conformation of monomer. (FIG. 2B) The self-complementary interactions between adjacent monomers. The head-to-tail anti-parallel packing and proximity of double bonds enable [2+2] dimerization. (FIG. 2C) The monomers form an infinite linear superstructure with the unpaired arms. (FIG. 2D) Single-crystal (super)structure of a partially polymerized structure. All the pairs of double bonds (highlighted by the purple circle) form cyclobutane rings. About half of the pairs of double bonds (highlighted by the green circle) form cyclobutane rings. (FIG. 2E) Single-crystal structure of the final polymer. All the pairs of double bonds form cyclobutane rings. (FIG. 2F) The positively charged linear backbone. All the monomers are connected covalently with each other by the newly formed cyclobutane rings. The purple wave shows the path of the backbone in crystal. The counterions and hydrogen atoms have been omitted for the sake of clarity.

FIGS. 3A-3B show single-crystal structure of monolayer and the lamellar superstructure in the polymer crystals. (FIG. 3A) In the monolayer, BF₄⁻ counteranions hold the alternatively aligned polymer chains together and form a 2D sheet. The adjacent chains are illustrated as stick representation and depicted as red, blue and green in order to differentiate their positions. The disordered BF₄⁻ counterions are shown in a space-filling representation in order to emphasize their multiple interactions. (FIG. 3B) Lamellar AB stacking arrangement of the monolayers. The two adjacent monolayers are depicted as light green and light magenta in order to differentiate them.

FIGS. 4A-4G show the morphology of polymer crystals and structural characterizations of exfoliated monolayer sheet. (FIG. 4A) Optical microscopic image. (FIG. 4B), (FIG. 4C), and (FIG. 4D) SEM images (2 kV) of the as-prepared polymer crystals. (FIG. 4E) AFM image of an exfoliated monolayer sheet with micrometer-size scale on SiO₂/Si substrate. (FIG. 4F) AFM height profile recorded the selective area along the black line indicated in (FIG. 4E). (FIG. 4G) Single-crystal structure of monolayer with a height of 1 nm, in which polymer chains are held alternatively by BF₄⁻ counterions.

FIGS. 5A-5F show mechanical properties and proton conductivities. (FIG. 5A) Typical force-displacement curves of nanoindentation tests performed on a crystal before (monomer) and after (polymer) UV irradiation. (FIG. 5B) Determined hardness, and (FIG. 5C) Young's modulus. Error bars represent the standard deviation of 34 indentation measurements of the same crystals. (FIG. 5D) Nyquist plots showing the impedance of the polymer at 298 K with varying relative humidity (RH) between 0.1 MHz-0.1 Hz. The Nyquist plots of 50%-90% RH are also shown. (FIG. 5E) The dependence of the proton conductivity of the polymer on the RH. (FIG. 5F) A snapshot of water chains in the 1D channels of the simulated structure. H₂O molecules are illustrated as space-filling representations, while the organic fragments and BF₄⁻ counterions are shown as surface model representations.

FIGS. 6A-6I show an overview of the single-crystal-to-single-crystal photopolymerization of one single crystal. FIG. 6A, Monomer single crystal. FIG. 6B, Single frame of the monomer matrix. FIG. 6C, Single crystal (super)structure of monomer. FIG. 6D, Intermediate single crystal. FIG. 6E, Single frame of the intermediate matrix. FIG. 6F, Single-crystal structure of intermediate. FIG. 6G, Polymer single crystal. FIG. 6H, Single frame of the polymer matrix. FIG. 6I, Single-crystal structure polymer. All the frames were recorded at 10 s exposure time.

FIG. 7 shows ¹H NMR Spectra for monitoring the polymerization. The samples were virtually insoluble in CD₃CN after irradiation of 9 h by sunlight.

FIG. 8 shows PXRD of the photopolymerization under sunlight at room temperature.

FIGS. 9A-9B show 41 NMR and CPMAS ¹³C NMR spectroscopies. FIG. 9A, The peaks around 5 ppm were assigned to protons in the newly formed cyclobutane rings. The polymeric crystals were virtually insoluble in CD₃CN after irradiation of 3 h. FIG. 9B, The insoluble polymer was characterized by solid-state ¹³C NMR spectroscopy. The new signal at δ=44 ppm showed the conversion of double bonds in monomer to cyclobutane rings in the polymer. Some third arms with double bonds still remain in the final structure of the polymer. The signal at δ≈60 ppm belongs to these unreacted arms.

FIG. 10 show IR Spectra of monomer and polymer crystals. There are no other obvious changes in the IR spectra apart from the peaks in the range of 1020 to 1160 cm⁻¹ became broad. The vibrational bands arising from newly formed bonds in cyclobutane rings were not present in the IR spectra. The peaks around the 1600 cm⁻¹ belonging to the double bonds did not disappear because there is still one arm left in the polymer structure.

FIG. 11 show ¹H NMR spectroscopy of monomer (bottom), amorphous monomer under UV for 3 h (middle) and monomer crystals under UV for 3 h (top). No notable changes in the ¹H NMR spectroscopy of amorphous monomer under UV for 3 h. After irradiation for 3 h under the same conditions, the monomer crystals, however, polymerized. This result indicates that the pre-assembly of monomer in crystals is essential for the topochemical photopolymerization to occur.

FIGS. 12A-12B show in-situ powder X-ray diffractometer (PXRD) for monitoring the photopolymerization. FIG. 12A, The setup of in-situ PXRD. The monomer crystals were sealed in a capillary and irradiated by UV continuously (0-13 h) at below 100 K. FIG. 12B, PXRD patterns for crystal samples of monomer, intermediate and polymer at 100 K. There were no obvious differences between the PXRD patterns because the unit-cell parameters are slightly different.

FIG. 13 shows in-situ PXRD patterns for monitoring the photopolymerization at 100 K. There were no virtual changes during the polymerization because the unit-cell parameters changed slightly.

FIG. 14 shows low magnification TEM images. The laminar structures were clearly shown at the edges of the sample.

FIG. 15A-15F shows HRTEM images with distinct crystal lattice fringes and well-distinguishable selected area electron diffraction (SAED) FIG. 15A, HRTEM images of bulk samples with distinct crystal lattice fringes (FIG. 15B and FIG. 15C). FIG. 15D, HRTEM images of exfoliated samples with distinct crystal lattice fringes (FIG. 15E) and SAED (FIG. 15F).

FIG. 16 show a schematic diagram for the exfoliation of polymer crystals to monolayer sheets.

FIG. 17 shows anisotropic 3D representation of the Young's moduli (in GPa) of the polymer crystal.

FIG. 18 shows TGA curves of monomer and polymer under Nz. The decomposition temperatures of monomer and polymer are 463 and 513 K.

FIG. 19 shows TGA and DSC curves of the polymer under Nz. No phase transitions or depolymerization before the decomposition of the polymer.

FIG. 20 shows ¹H NMR spectra of monomer, polymer and polymer after DSC measurement (bottom-to-top). There is no detectable degradation of the polymer samples, which were heated up to 503 K during the DSC, measurement in the ¹H NMR spectra.

FIG. 21 show ¹H NMR spectra of monomer, polymer and polymer after irradiation under UV light (λ=254 nm) for 36 h (bottom to up). There no detectable degradation observed in the ¹H NMR spectra.

FIG. 22 shows VT-PRD patterns of monomer 1•3BF₄ (from 100 to 220 K). The changes of the patterns at 190 and 220 K can be ascribed to the melt of solvents during the measurement (the melting points of iPrzO and MeCN are 187 and 225 K, respectively).

FIG. 23 shows VT-PRD patterns of monomer 1•3BF₄ (from 220 to 400 K). Even when the crystals were heated up to 400 K, the high crystallinity was still retained.

FIG. 24 shows VT-PRD patterns of polymer 2•nBF₄ (from 220 to 400 K). When heated to 400 K, the polymer crystals lost their crystallinity. After the SCSC topochemical polymerization, the quality of the crystals decreased.

FIG. 25 shows equivalent circuit model used to fit the impedance data. A Constant Phase Element (CPE) was used to describe the non-ideal interface capacitance, R_{b} and C_{b} represent the resistance and capacitance of the sample, respectively.

FIG. 26 shows kinetic isotope effect of the polymer at 90% RH. A Nyquist plot for the polymer-bridged two-terminal device in the presence of water vapour (black) and in the presence of deuterium oxide vapour (red). The conductivity calculated from the Nyquist plots are 3×10⁻⁴ S cm⁻¹ (H⁺) and 1.4×10⁻⁴ S cm⁻¹ (D⁺), respectively.

### DETAILED DESCRIPTION OF THE INVENTION

Here, we present a rational design for PSCs. Topochemical polymerization, a lattice-controlled crystal-to-crystal synthetic protocol, allows for the preparation of macroscopically sized single-crystalline polymers, suitable for single-crystal X-ray diffraction (SCXRD). This solid-state technique not only provides the accurate chemical composition but also affords detailed bonding information, thereby offering guidelines for the further development of materials with finely tuned properties. The high crystallinity of these materials can also enhance performance-based applications.

The schemes and compositions disclosed herein provide for the efficient preparation of PSCs on the basis of a selection of appendages in ionic monomer molecules. These appendages or arms dictate an ensemble of weak interactions and spatial alignments, by combining the principles of supramolecular chemistry and macromolecular science.

One aspect of the invention is a supramolecular composition. The supramolecular composition may comprise an ordered arrangement of a plurality of organic ions and a plurality of counterions. The organic ions comprising a molecular hub and polymerizable arms extending therefrom. The polymerizable arms are capable of interacting with each other through various noncovalent interactions, such as hydrogen bonding and π-π interactions. Conformational flexibility of the polymerizable arms around the molecular hub provide the organic ion the ability to adopt a stable conformation in three dimensions and preorganize discrete reaction sites into an infinite and highly ordered supramolecular network.

The molecular hub provides a focal point from which the arms can extend. Some or all of the arms extending from the molecular hub may comprise a polymerizable arms. Suitably, the organic ions adopt an ordered arrangement where the polymerizable moieties between neighboring organic ions may react with one another thereby forming polyelectrolyte polymer molecules and polyelectrolyte crystals. Each of the polymerizable arms may comprise a strain-releasing group, a charge-bearing aryl, a polymerizable moiety, and a second aryl.

The polymerizable moiety may be any moiety capable of participating in a polymerization reaction. Suitably the polymerizable moiety is capable of participating in a cycloaddition reaction, such as a [2+2] cycloaddition. Exemplary polymerizable moieties include, without limitation, ethylene, acetelyene, or diacetylene.

The strain-releasing group may be any chemical group that can provide conformational flexibility or cushion the strain released from conformational changes that take place during solid-state reactions and so prevent fragmentation of the crystals. In some embodiments, the strain-releasing group is a C₁-C₃ alkylene, that may be optionally substituted or unsubstituted. —CH₂— is used as a strain-releasing group in the Examples, but the strain-releasing also be —CH₂CH₂— or —CH₂CH₂CH₂—.

As used herein aryl is art-recognized and refers to a carbocyclic aromatic group. Representative aryl groups include phenyl, pyrindinyl, and the like. Unless specified otherwise, the aromatic ring may be substituted at one or more ring positions. In certain other embodiments, the aromatic ring is not substituted, i.e., it is unsubstituted. A charge-bearing aryl is an aromatic group that can bear be positively or negatively charged such as a pyrindinyl or the like.

In some embodiments, the polymerizable moiety may be positioned between pyrindinyl rings or between a pyrindinyl and a phenyl ring. Exemplary arms comprise

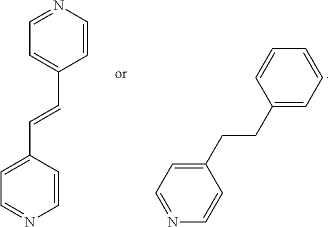 [SMILES: C(=C\c1ccncc1)/c1ccncc1 ; c1ccc(CCc2ccncc2)cc1]

The organic ion may comprise two or more polymerizable arms capable of preparing the supramolecular composition where at least some of the polymerizable moieties are capable of reacting with one another. Suitably the organic ion has 2, 3, 4, 5, or 6 polymerizable arms. The charge of the organic ion may be proportional to the number of polymerizable arms bonded to the molecular hub, but that need not be the case. Suitably an organic ion having 2, 3, 4, 5, or 6 arms may have a 2+, 3+, 4+, 5+, or 6+ charge, respectively.

In some embodiments, the organic ion comprises one or more additional arms that are incapable of polymerizing. In some embodiments, the additional arms incapable of polymerizing may be a C₁-C₄ alkyl, that may be optionally substituted or unsubstituted. The organic ions referred to in the examples have methyl arms.

Suitably the molecular hub may be selected to allow for the organic ions to adopt stable confirmations for polymerization. Suitably, the molecular hub may a benzene ring

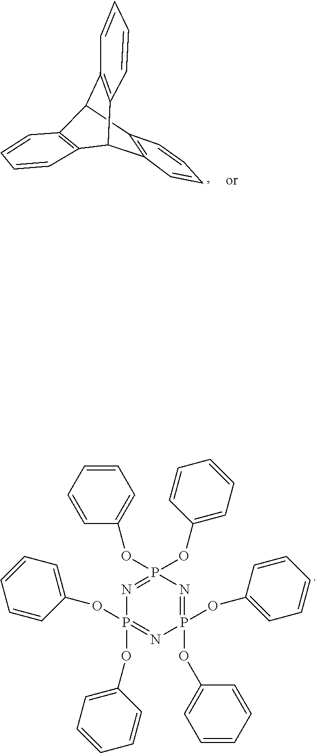

When the molecular hub is a benzene ring, some or all of the carbon atoms of the benzene ring may be covalently bonded with a polymerizable arm. Suitably, when some of the carbon atoms of the benzene ring are not covalently bonded with a polymerizable arm, the carbon atoms of the benzene ring may be bonded to hydrogen or a C₁-C₄ alkyl, such as methyl.

The counterion allows for the formation of the supramolecular assembly, polyelectrolyte polymers, and polyelectrolyte crystals described herein. Suitably the counterion is BF₄⁻, a halo, such as Cl⁻ or Br⁻, or a hexafluoride, such as PF₆⁻ or AsF₆⁻.

The present technology will be further described by way of example with the preparation of supramolecular composition, polyelectrolyte polymers, and polyelectrolyte crystals using the tricationic organic ion

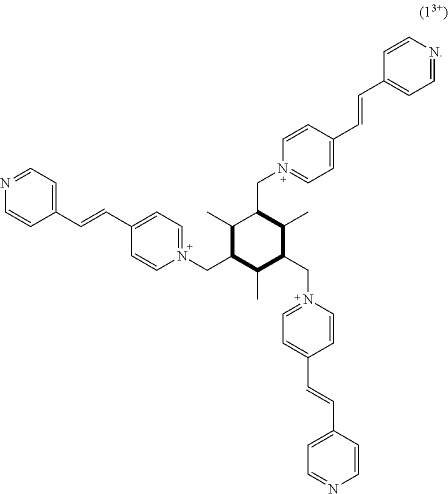

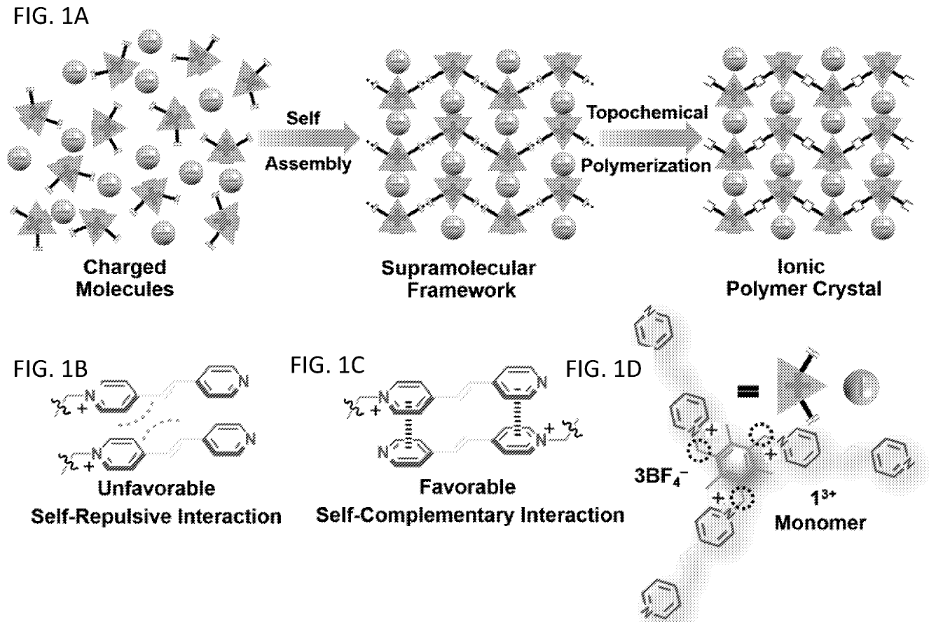

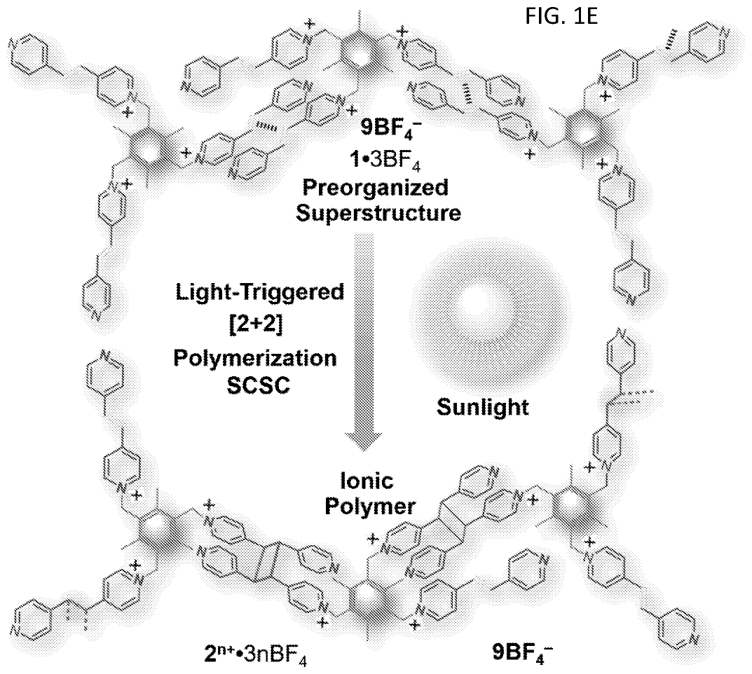

Self-complementary shape and charge distribution interactions between pyridinium-based polymerizable arms that may involve the repulsive monomeric units allow for optimal proximity for topochemical reactions (FIGS. 1A-1C). The triolefinic tripyridinium monomer 1³⁺ is able to adopt a stable conformation in three dimensions and so preorganize discrete reaction sites into an infinite and highly ordered supramolecular network. Moreover, flexibility, highlighted by the black dotted circles in FIG. 1D, associated with the three polymerizable arms of the monomeric structure is also considered in order to cushion the strain released from conformational changes which take place during solid-state reactions and so prevent fragmentation of the crystals. The remarkable advantage of this strategy is its ability to obtain large-sized polycationic polymer single crystals quantitatively by taking advantage of an ultraviolet/sunlight-induced SCSC topochemical photopolymerization (FIG. 1E) of the preorganized monomer molecules, resulting from the crystallization.

Synthesis and single-crystal structure of the monomer. The monomer molecule was synthesized (Scheme 1) on a two-gram scale with no chromatographic purification in 80% yield in two steps from the commercially available starting materials, 1,3,5-tris(bromomethyl)-2,4,6-trimethylbenzene and (E)-1,2-di(pyridin-4-yl)ethene, followed by the counterion exchange with NH₄BF₄. The resulting monomer 1•3BF₄ is soluble in polar organic solvents.

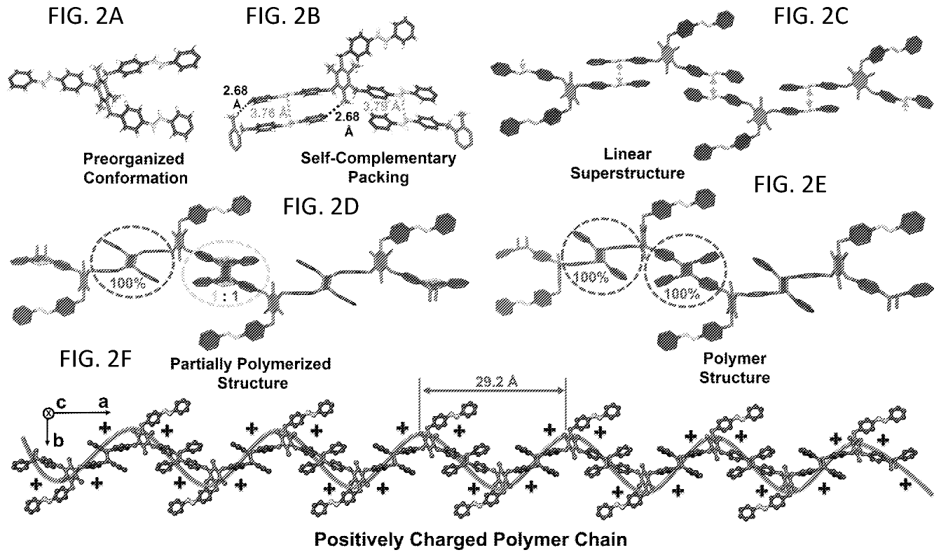

Colorless plate-like single crystals of 1•3BF₄, suitable for SCXRD, were obtained by slow vapor diffusion of iPr₂O into a MeCN solution of the salt. SCXRD Analysis reveals that adopts (FIG. 2A) a conformation wherein two trans-styryl pyridinium arms are oriented in one direction, while the third arm is oriented in the opposite direction as dictated by the trisubstituted mesitylene ring. The organic trication is surrounded by three BF₄⁻ counterions. Two of three pyridinium arms from each trication adopt anti-parallel co-conformations with those in adjacent molecules so as to connect (FIG. 2B) two adjacent trications by means of self-complementary interactions. This antiparallel packing of the pairs of head-to-tail pyridinium arms within the solid-state superstructure places the centroids of the alkene double bonds at distances, highlighted by dashed lines in FIG. 2B, of 3.76 and 3.79 Å, respectively. The tiny difference in these two distances may be a result of the presence of an additional [C—H⋅⋅⋅N] interaction, highlighted by a black dashed line in FIG. 2B. Both the face-to-face stacking geometry and distances between pairs of double bonds meet Schmidt's criterion³⁵ for the photo-induced [2+2] cycloaddition. The pyridinium pairs of the monomer molecules form (FIG. 2C) an infinite linear superstructure in which all the neighboring monomers are integrated noncovalently in the crystal. The third arm of the monomer, however, is free and does not form pairs using similar self-complementary interactions with adjacent monomers. As a consequence, topochemical polymerization is expected to afford linear ionic polymer chains without any crosslinking by covalent bonds.

Single-crystal-to-single-crystal photopolymerizations. We conducted topochemical reactions on monomer single crystals and monitored the polymerizations directly by in-situ SCXRD. Irradiation of crystals with ultraviolet light (λ=365 nm) at 100 K for 3 h resulted in the formation of partially polymerized samples. Prolonging the irradiation on these crystals for 9 h under the same conditions led to the final crystalline polymers. Both the intermediates and final crystalline polymers share the same C2/c space group with the monomer, while the unit-cell parameters are slightly different. As the polymerization proceeds, unit-cell parameters a and b decrease slightly, while c increases slightly, thereby leading (Table 1) to an increase in the overall cell volume.

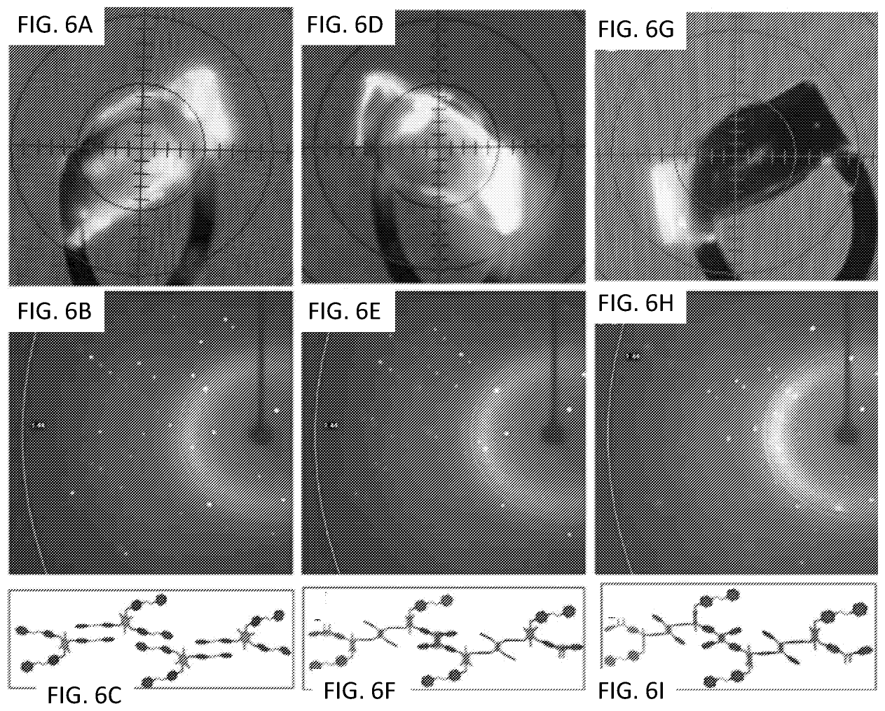

SCXRD Analysis of the intermediate crystal reveals (FIG. 2D) that the polymerizations do take place and that the preorganized assemblies of reactive sites guarantee the regio- and stereoselective formation of rctt-(1,3-(4-pyridin-1-ium), 2,4-(4-pyridyl))cyclo-butane derivatives. All the pairs of double bonds—highlighted by the purple circle in FIG. 2C—with an initial packing distance of 3.76 Å, form cyclobutane rings. About half of the pairs of double bonds—highlighted by the green circle in FIG. 2D—with a longer initial packing distance of 3.79 Å in the monomers, also form cyclobutane rings. The conversion ratio can be estimated from the electron densities in the refined crystal structures³⁶. The mean positions and occupancies of atoms in the partially polymerized structure can be determined by X-ray crystallography from three-dimensional maps of the electron densities. These observations indicate that the shorter the packing distance between the reactive sites, the faster the topochemical reaction. In the crystalline polymers (FIG. 2E), all monomeric units are connected covalently with each other by the newly formed cyclobutane rings—highlighted by the purple circle in FIG. 2E—in positively charged linear backbones. The resulting chains are oriented (FIG. 2F) along the long crystallographic a axis and the length of the repeating unit is 29.2 Å. The crystalline polymers are totally insoluble in common organic solvents. The molecular weight is estimated to be very large. Since the crystalline polymers are insoluble in common organic solvents, it is not possible to measure their molecular weights and degrees of polymerization using the well-known techniques for characterizing polymers. On the basis of single-crystal structures, the molecular weight (M) and degree of polymerization (DP) per μm are estimated to be 662 kg mol⁻¹ and 685, respectively This crystallographically characterized process with molecular precision demonstrates (FIGS. 6A-6I) unambiguously the photopolymerization is an SCSC transformation. The fact that the photopolymerization cannot be conducted on the amorphous monomer was verified by the observation that there were no notable changes in the ¹H NMR spectrum of the amorphous monomer under UV irradiation for 3 h.

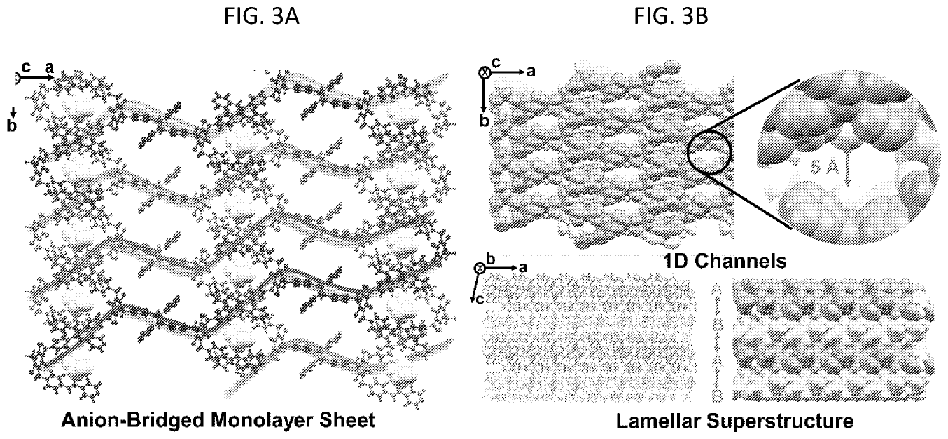

The alternatively aligned polymer chains are held together tightly by BF₄⁻ counterions entering into multiple electrostatic interactions to form (FIG. 3A) 2D sheets. The multiple electrostatic interactions between BF₄⁻ counterions and the positively charged polymer chains are strong enough to allow the isolation of the ionic monolayers, which have been confirmed by atomic force microscopy (AFM). Further superstructural analysis (FIG. 3B) disclosed the lamellar AB stacking arrangement of the monolayers. 1D Channels with diameters of about 5 Å run all along the crystallographic c axis. The neighboring monolayers are connected by electrostatic interactions and van der Waals forces.

### Sunlight-Triggered Polymerizations and Gram-Scale Syntheses

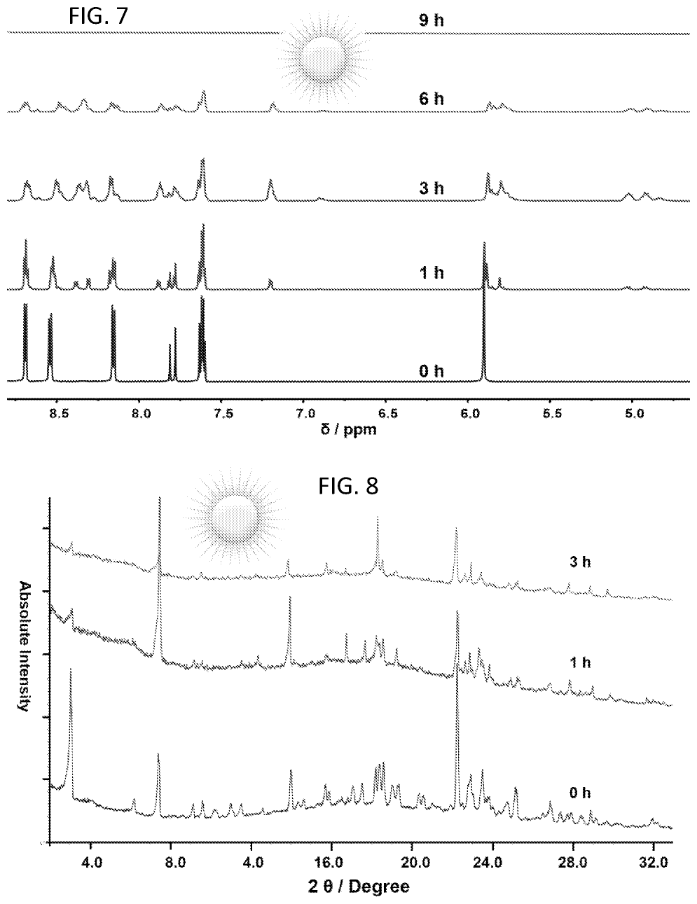

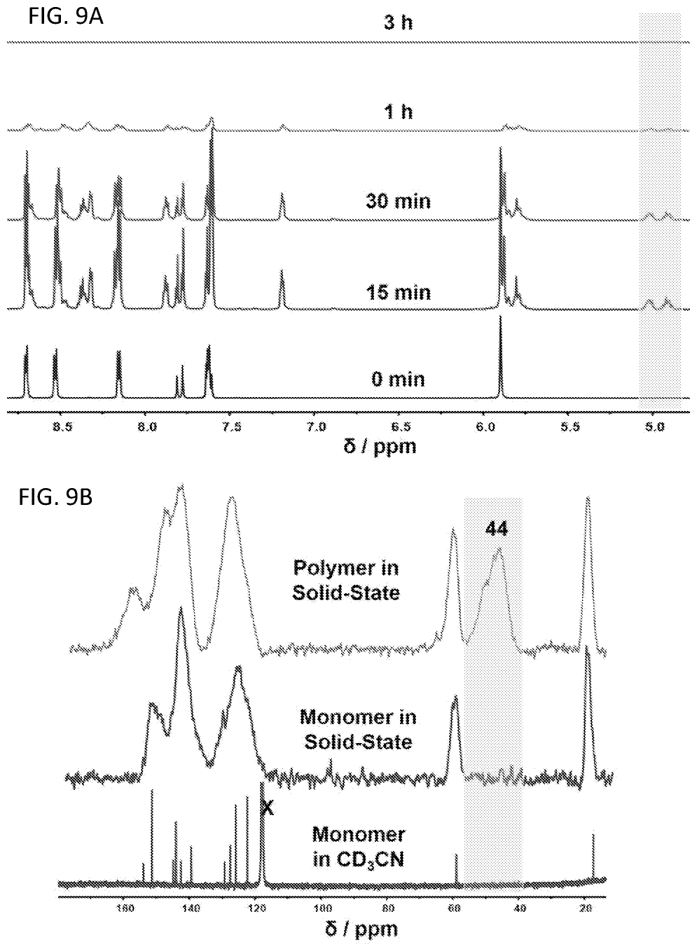

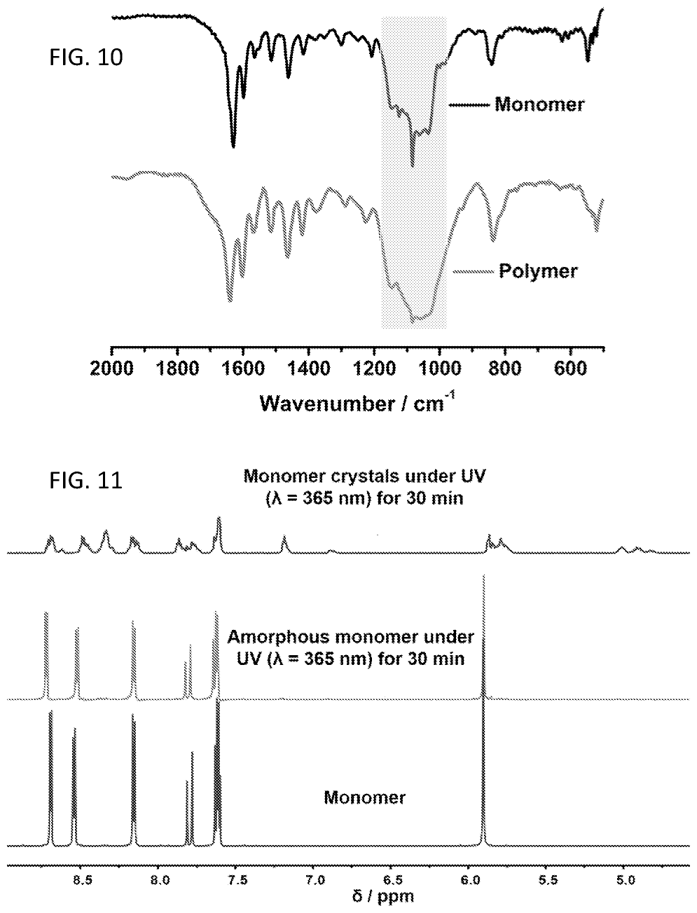

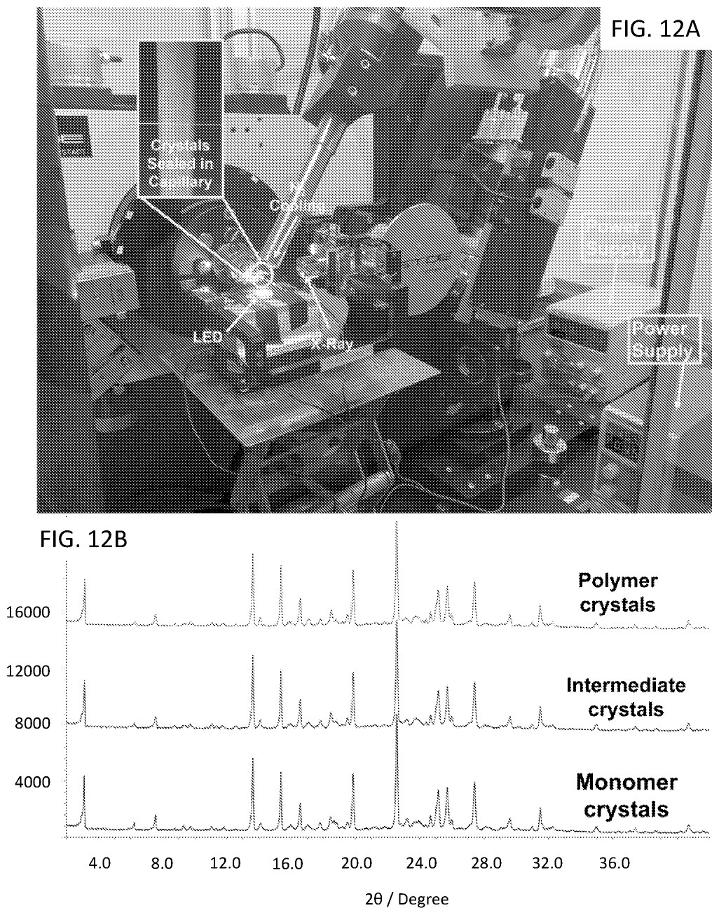

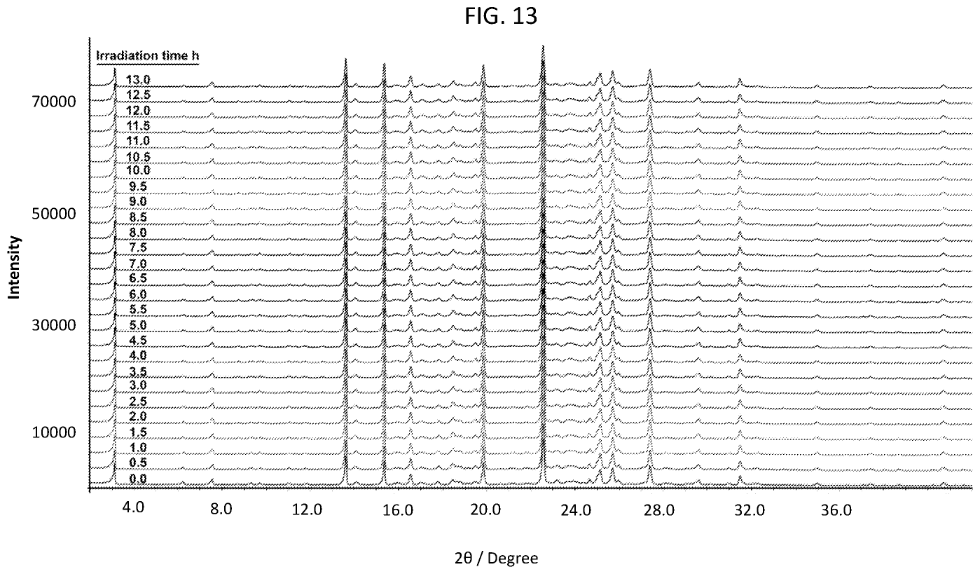

The polymerizations can also be triggered by sunlight. Crystals of the monomer, when left outdoors under sunlight for 2 days, became insoluble in all common organic solvents. The presence of ionic polymers in these samples was also verified by 41 NMR spectroscopy (FIG. 7) and PXRD (FIG. 8). The PXRD peaks were recorded at room temperature after the crystalline monomers had been left outdoors in sunlight for 0, 1, and 3 h. The quality of these PXRD peaks recorded at room temperature was not as good as those obtained after UV irradiation of the crystalline monomers at 100 K. In general, the lower the temperatures at which the PXRD is recorded, the better are the qualities of the PXRD peaks. In order to obtain sufficient samples to study the physicochemical properties comprehensively and test the ionic polymer for practical applications, a gram-scale synthetic procedure was developed. One gram of plate crystals of monomer 1•3BF₄ were dispersed in a solvent mixture of MeCN and iPr₂O (1:10) and irradiated at room temperature for 9 h. The topochemical polymerizations were monitored (FIGS. 9A, 9B, 10, 11, 12A, 12B, 13) by infrared spectrophotometry (IR), powder X-ray diffraction (PXRD), ¹H NMR spectroscopy and solid-state cross-polarization magic angle spinning (CPMAS) ¹³C NMR spectroscopy. The results from IR, PXRD, ¹H NMR, and CPMAS ¹³C NMR spectra, taken together, indicated that the polymerizations had gone to completion quantitatively on a gram-scale.

### Morphology and Exfoliation

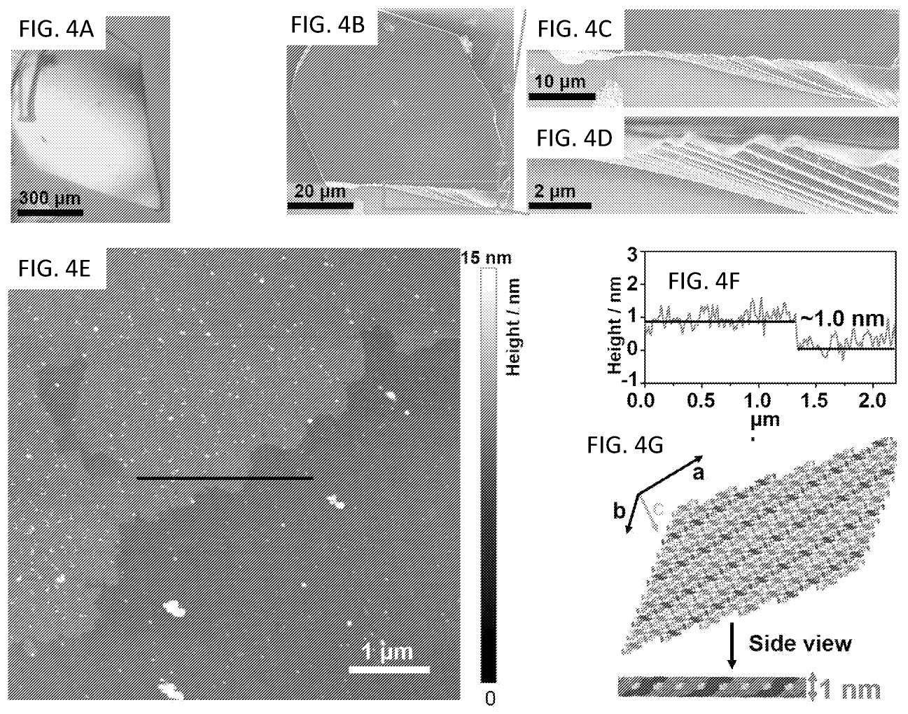

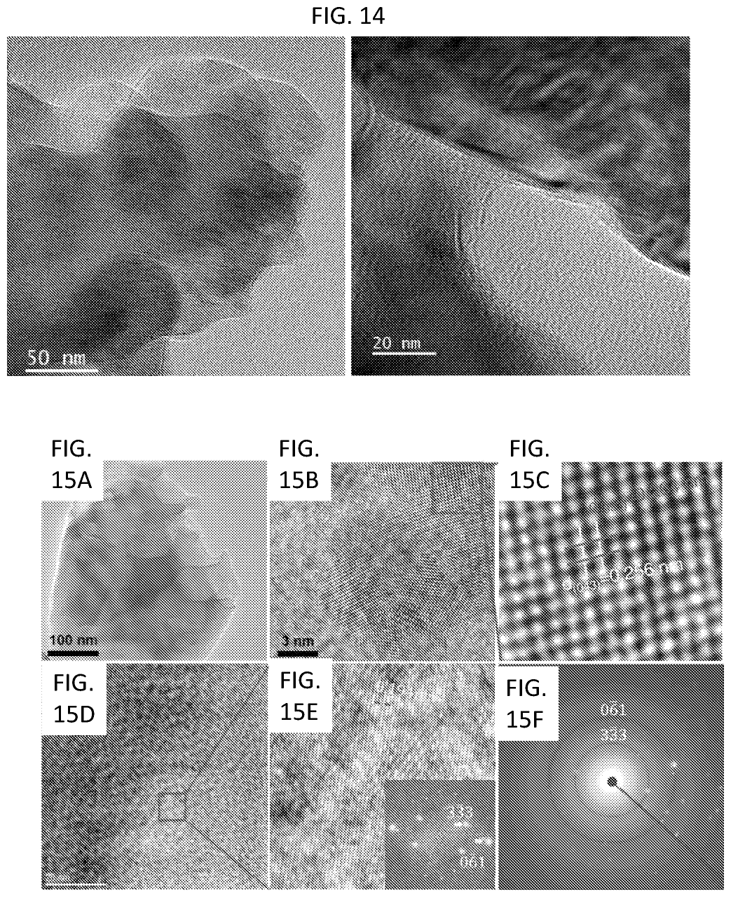

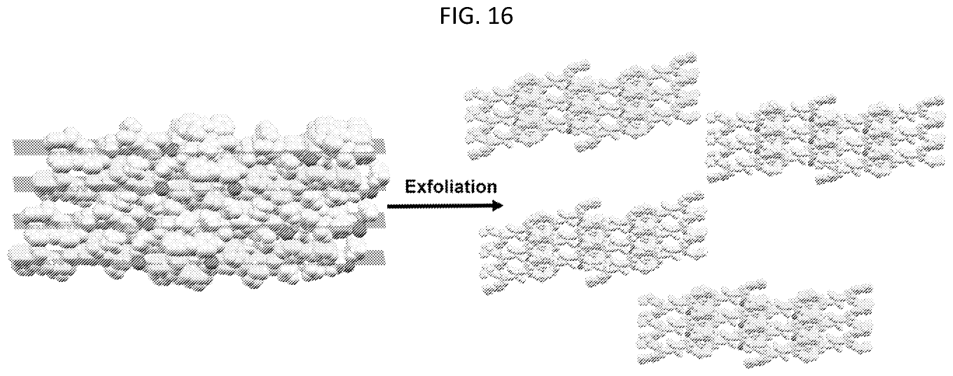

The optical microscopic and scanning electron microscopic (SEM) images (FIGS. 4A and 4B, respectively) of the crystalline polymers exhibit platelet morphologies with apparently smooth surfaces. The average length and width of the platelets are around 850 and 660 μm, respectively. The thicknesses have been estimated from the face index file of SCXRD to be 100 μm. Careful examination of particular edges in the SEM images (FIGS. 4C-4D) suggests lamellar characteristics for the crystals. The laminar superstructures were also identified (FIG. 14) by transmission electron microscopy (TEM). All the high resolution TEM (HRTEM) images exhibit (FIG. 15A-15F) well-ordered linear features. Considering the fact that most organic molecules are sensitive to electron beams, and the fact that they cannot withstand the harsh conditions for high-resolution imaging, it is noteworthy that the high quality of all the HRTEM images is commensurate with the exceptional stability of these charged crystalline polymers.

Inspired by the top-down delamination of bulk graphite, which produces⁴⁰ 2D monolayer graphene, liquid-phase exfoliation has been explored to break down 1D⁹ and 2D^{10,11,41} crystalline materials. In order to achieve a thorough exfoliation (FIG. 16), the ionic crystalline polymers were stirred in γ-butyrolactone (GBL) at 323 K for 5 days. This exfoliation led eventually to 2D monolayer sheets. AFM Images (FIG. 4E) on SiO₂/Si substrates show micrometer-size monolayers with sharp edges. The heights of the observed sheets are measured (FIG. 4F) to be around 1 nm, a number which is in good agreement with the thickness of the monolayers (FIG. 4G) in the crystal structure. Prolonging exfoliations for more than one month did not lead to the formation of any single or multiple polymer chains. The completely exfoliated monolayer sheets rely on strong ionic bonds between the polymer chains and BF₄⁻ counterions, which hold the highly ordered interchains together, thus forming 2D sheets. These ionic, molecule-thin monolayers with micrometer dimensions and subnanometer pores have the potential to be fabricated into membranes for reverse osmosis, utilized in water desalination⁴².

### Mechanical Properties and Stabilities

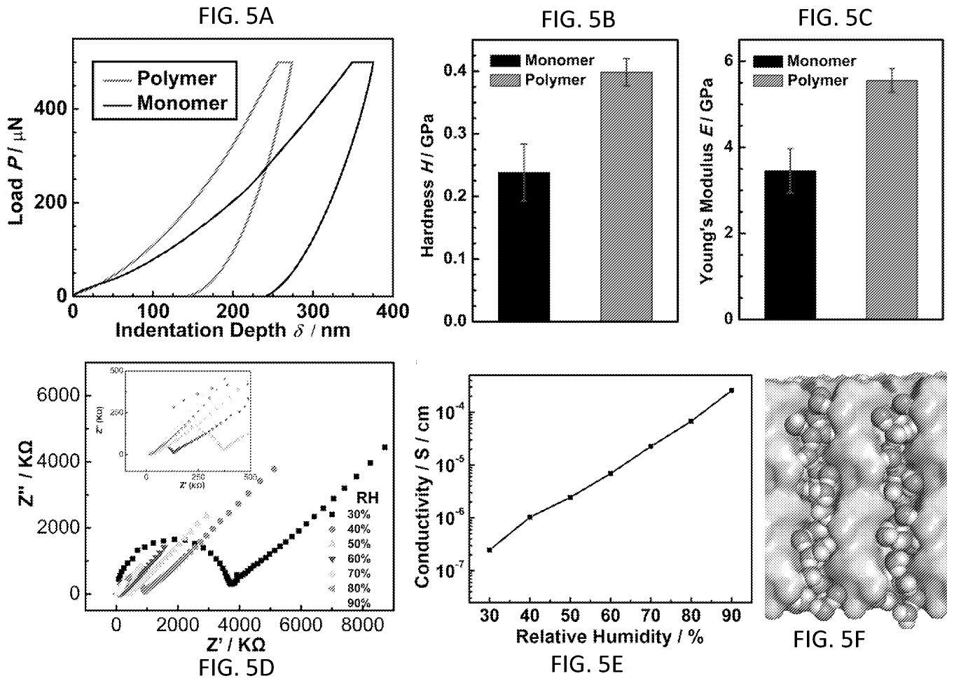

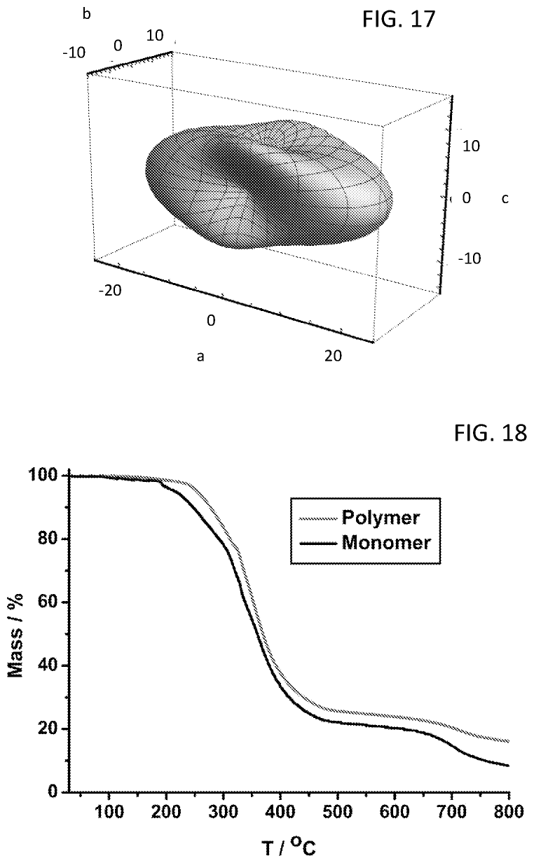

The intrinsic mechanical properties and environmental stabilities to heat, light, etc. are important characteristics of polymers. The hardness (H) and the Young's modulus (E) of the monomer and polymer were measured (FIGS. 5A-5C) along the crystallographic c-axis using a nanoindentation technique⁴³. Nanoindentation was performed at room temperature under normal atmospheric pressure. Hardness and Young's moduli were measured on a Hysitron 950 Tribolndenter with a Berkovich indenter (radius 100 nm). The data were analyzed using standard Oliver and Pharr analysis. The hardness of the 1•3BF₄ monomer crystal is H₀₀₁=0.24±0.05 GPa, while Young's modulus is E₀₀₁=3.45±0.51 GPa. After irradiation for 12 h, these values increased by 67% and 61%, respectively. The hardness and Young's modulus of the polymer crystal are H₀₀₁=0.40±0.02 GPa and E₀₀₁=5.56±0.27 GPa. The Young's modulus for the polymer crystal was in excellent agreement with our theoretical results (E₀₀₁=5.62 GPa). The theoretical results indicated, however, that the crystal has a highly anisotropic mechanical response, as shown in FIG. 17. The mechanical properties of this organic crystalline polymer are comparable⁴⁵ with those of typical metal-organic frameworks⁴⁶ (MOFs), while they are stiffer than well-known polymers, such as Nylon-6 (E=3.15 GPa), Polystyrene (PS, E=3.72 GPa), and Poly(methyl methacrylate) (PMMA, E=3.83 GPa)⁴⁷.

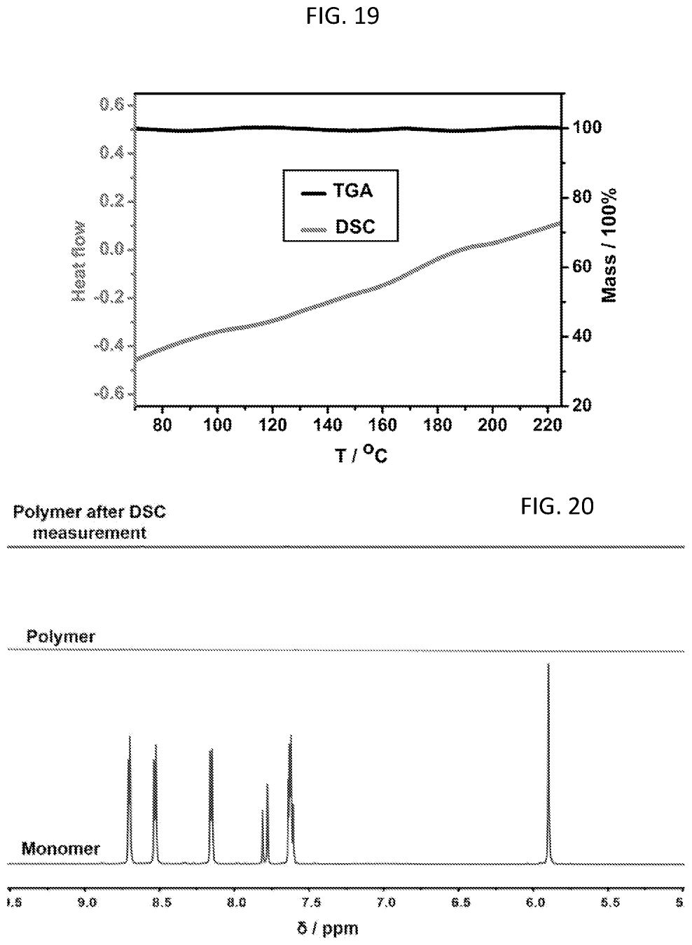

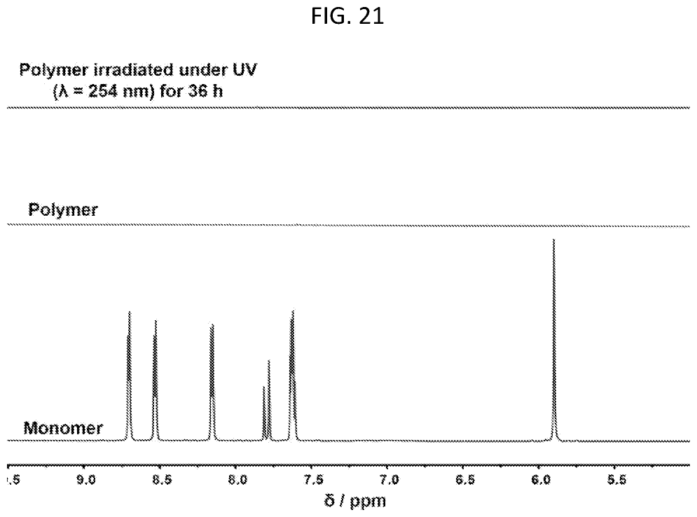

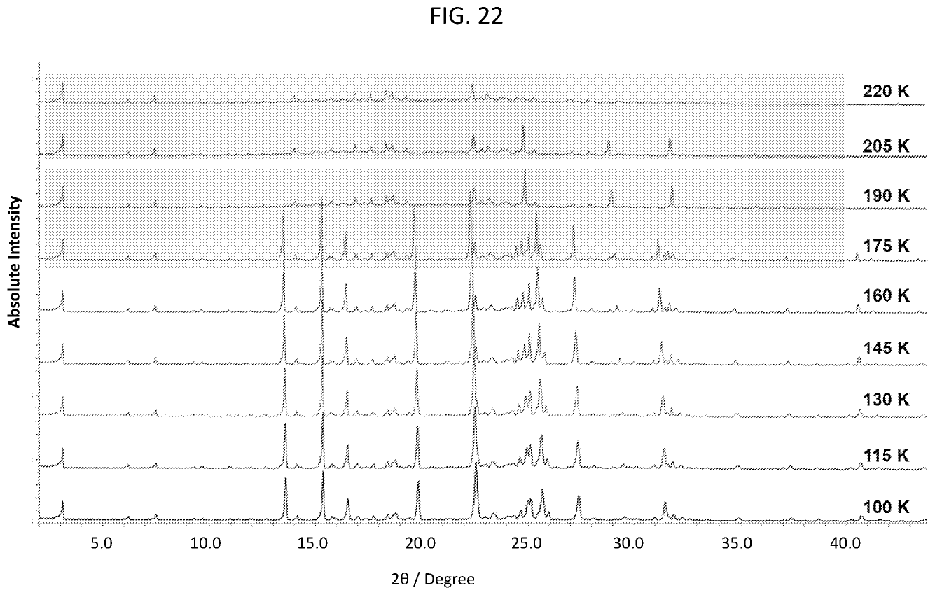

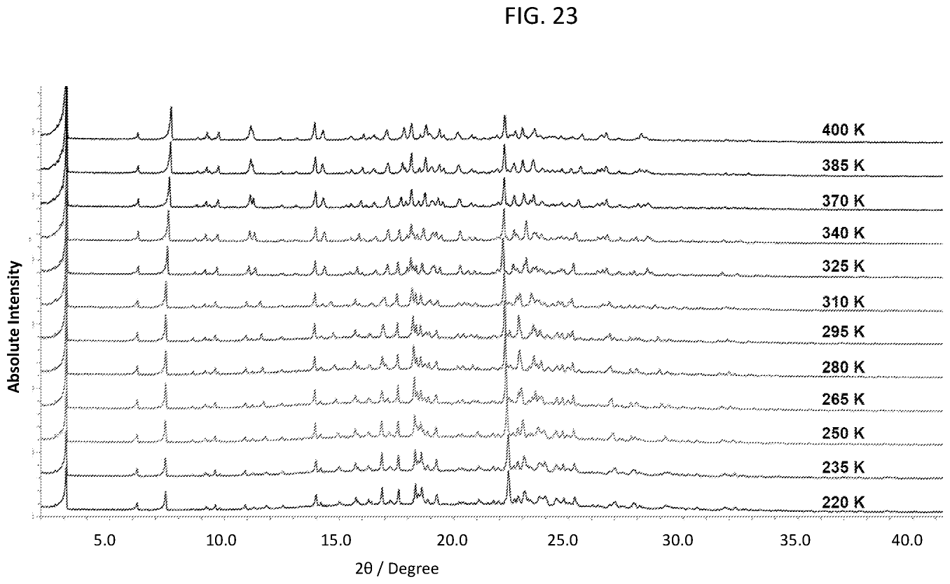

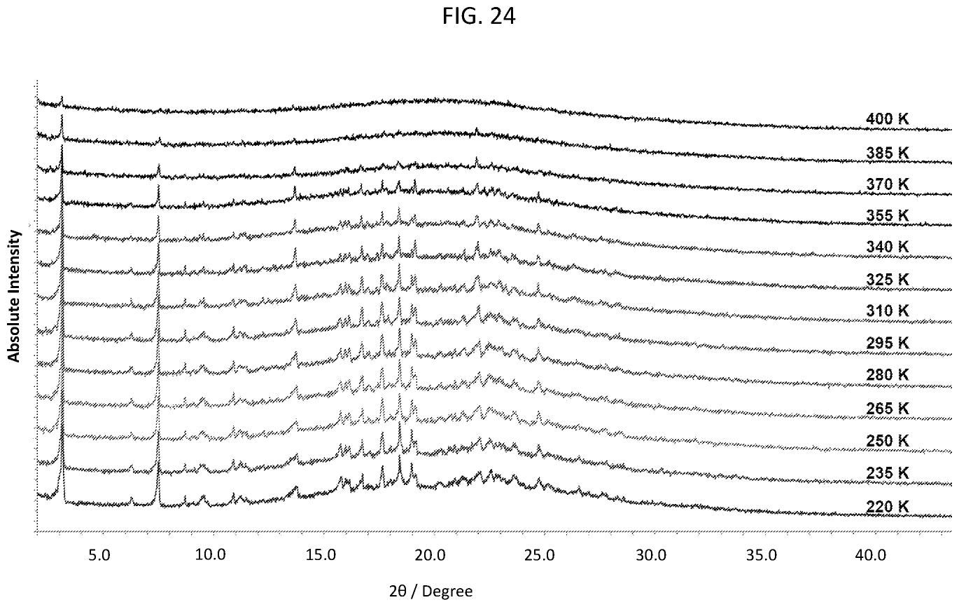

Thermogravimetric analysis (TGA) and differential scanning calorimetry (DSC) measurements on the polymer samples showed (FIGS. 18-20) no phase transition or evidence for depolymerization prior to the decomposition of the polymer at around 500 K. In addition, following irradiation under UV light (λ=254 nm) for 36 h, no chemical degradation was detected (FIG. 21) by ¹H NMR spectroscopy. Meanwhile, the crystallinities of both the monomer and polymer—as assessed (FIGS. 22-24) by PXRD—were still retained, even when the crystals were heated up to 400 K. All of these observations, taken together, validated the inherent stability of the crystalline polymers upon heating and radiating with UV light (λ=254 nm). The formation of cyclobutane is reversible under thermal⁴⁸ or photochemical⁴⁹ conditions. We anticipate that the strong electrostatic interactions present in the polymer chains stabilize the cyclobutane rings and thus prevent the depolymerization of the rigid backbones. Moreover, the polymer is extremely stable towards harsh chemical conditions. Polymer samples, when soaked in various concentrated acids—37% hydrochloric acid, 98% trifluoroacetic acid and glacial acetic acid—for more than three months, maintained their morphology, physical integrity, and chemical composition, despite the fact that their crystallinities were lost. After soaking the crystalline polymer in various concentrated acids for three months, the chemical composition of the resulting polymer underwent small changes. The BF₄⁻ counterions can be exchanged partially by the anions associated with the acids. Meanwhile, H₂O was adsorbed into the polymer.

### Proton Conductivity

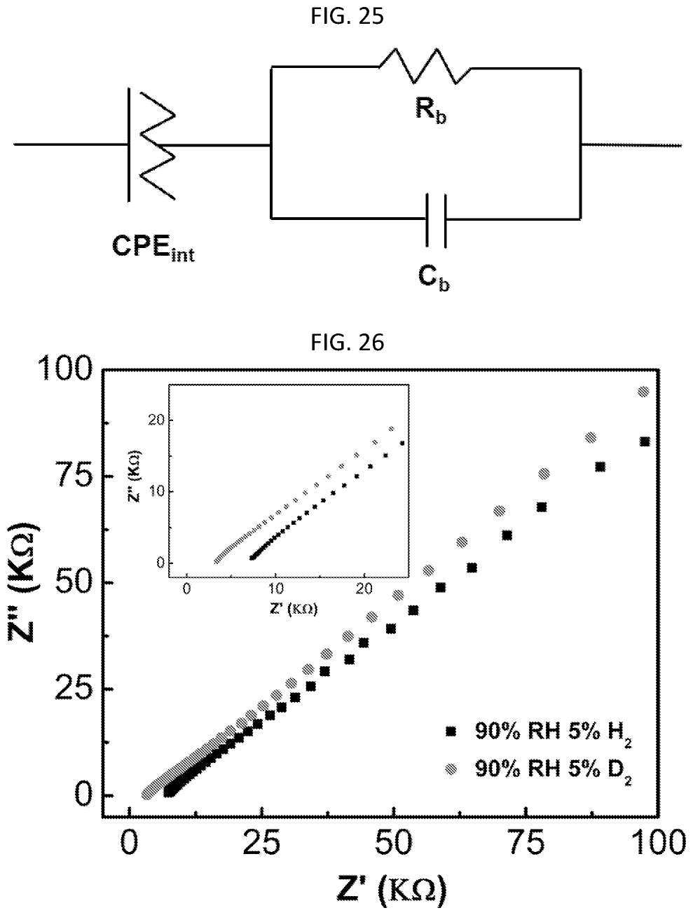

Given the ordered 1D ionic channels, high stability towards heat and concentrated acids, we investigated the proton conductivity of the polymer using electrochemical impedance spectroscopy (EIS). The Nyquist plots show (FIG. 5D) a semicircle in the high-frequency region and an inclined spur in the low-frequency region, both observations that can be associated with a simple equivalent circuit (FIG. 25). The values (FIG. 5E) for proton conductivities are highly humidity dependent and show a significant increase from 2.5×10⁻⁷ S cm⁻¹ at 30% relative humidity (RH) to 2.6×10 S cm⁻⁴ at 90% RH. A distinct isotope effect confirmed⁵²⁻⁵⁴ that the polymer is a proton conductor (FIG. 26). Measured in H₂O to D₂O, respectively, the Nyquist plots showed identical shapes, while the conductivities shifted from 3×10⁻⁴ to 1.4×10⁻⁴ S cm⁻¹. Because the mass of deuterium is two times larger than that of proton, the charge mobility or the conductivity of a deuterium, is approximately half that of a proton. This deuterium effect is a solid indication that the crystalline polymeric material is a proton conductor rather than a conductor of other charges. The impressive proton conductivities (˜3×10 S⁻⁴ cm⁻¹) at room temperature are broadly comparable (Table 4) with the values for covalent organic frameworks (COFs) measured under similar conditions. The simulated structure reveals that water molecules form (FIG. 5F) hydrogen-bonded networks in the confined environment of the 1D channels, suggesting the operation of a Grotthuss mechanism⁵⁵ in which hydronium ions pass their protons to neighboring water molecules along the well-packed hydrogen-bonded chains. A more detailed analysis of the proton conductivity can be found in the Section K of the Examples.

### Conclusions

In summary, a strategy for the quantitative synthesis of polyelectrolyte single crystals with precise control over composition, regioregularity, stereoregularity, and tacticity, from a tricationic monomer is provided. The positively charged polymer chains are aligned periodically and held tightly together by multiple ionic interactions with tetrafluoroborate counterions to form 2D monolayer sheets in lamellar crystals. A gram-scale preparation, relying on ultraviolet/sunlight-triggered polymerization, has allowed us to synthesize enough of the polymer to be able to investigate its physicochemical properties and speculate about its potential practical applications. We have demonstrated that the highly ordered polycationic structure endows this charged polymer with valuable properties. High proton conductivities, in combination with the remarkable mechanical properties and the high thermal stabilities of these polyelectrolytes, point to their application as proton-conducting materials.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCES

(1) Colquhoun, H. M.; Williams, D. J. Crystal and Molecular Simulation of High-Performance Polymers. Acc. Chem. Res. 2000, 33, 189-198.
(2) Ma, T.; Kapustin, E. A.; Yin, S. X.; Liang, L.; Zhou, Z.; Niu, J.; Li, L. H.; Wang, Y.; Su, J.; Li, J.; Wang, X.; Wang, W. D.; Wang, W.; Sun, J.; Yaghi, O. M. Single-Crystal X-Ray Diffraction Structures of Covalent Organic Frameworks. Science 2018, 361, 48-52.
(3) Gu, Y.; Zhao, J.; Johnson, J. A. A Unifying Review of Polymer Networks: From Rubbers and Gels to Porous Frameworks. Angew. Chem., Int. Ed. 2019, 59, DOI:10.1002/anie.201902900.
(4) Hasegawa, M. Photopolymerization of Diolefin Crystals. Chem. Rev. 1983, 83, 507-518.
(5) Biradha, K.; Santra, R. Crystal Engineering of Topochemical Solid State Reactions. Chem. Soc. Rev. 2013, 42, 950-967.
(6) Hoang, T.; Lauher, J. W.; Fowler, F. W. The Topochemical 1,6-Polymerization of a Triene. J. Am. Chem. Soc. 2002, 124, 10656-10657.
(7) Sun, A.; Lauher, J. W.; Goroff, N. S. Preparation of Poly(Diiododiacetylene), an Ordered Conjugated Polymer of Carbon and Iodine. Science 2006, 312, 1030-1034.
(8) Kole, G. K.; Vittal, J. J. Solid-State Reactivity and Structural Transformations Involving Coordination Polymers. Chem. Soc. Rev. 2013, 42, 1755-1775.
(9) Dou, L.; Zheng, Y.; Shen, X.; Wu, G.; Fields, K.; Hsu, W.-C.; Zhou, H.; Yang, Y.; Wudl, F. Single-Crystal Linear Polymers through Visible Light-Triggered Topochemical Quantitative Polymerization. Science 2014, 343, 272-277.
(10) Kissel, P.; Murray, D. J.; Wulftange, W. J.; Catalano, V. J.; King, B. T. A Nanoporous Two-Dimensional Polymer by Single-Crystal-to-Single-Crystal Photopolymerization. Nat. Chem. 2014, 6, 774-778.
(11) Kory, M. J.; Worle, M.; Weber, T.; Payamyar, P.; van de Poll, S. W.; Dshemuchadse, J.; Trapp, N.; Schluter, A. D. Gram-Scale Synthesis of Two-Dimensional Polymer Crystals and Their Structure Analysis by X-Ray Diffraction. Nat. Chem. 2014, 6, 779-784.
(12) Lange, R. Z.; Hofer, G.; Weber, T.; Schluter, A. D. A Two-Dimensional Polymer Synthesized through Topochemical [2+2]-Cycloaddition on the Multigram Scale. J. Am. Chem. Soc. 2017, 139, 2053-2059.
(13) Jiang, X.; Cui, X.; Duncan, A. J. E.; Li, L.; Hughes, R. P.; Staples, R. J.; Alexandrov, E. V.; Proserpio, D. M.; Wu, Y.; Ke, C. Topochemical Synthesis of Single-Crystalline Hydrogen-Bonded Cross-Linked Organic Frameworks and Their Guest-Induced Elastic Expansion. J. Am. Chem. Soc. 2019, 141, 10915-10923.
(14) Gadjourova, Z.; Andreev, Y. G.; Tunstall, D. P.; Bruce, P. G. Ionic Conductivity in Crystalline Polymer Electrolytes. Nature 2001, 412, 520-523.
(15) Liu, Y.; Zhao, J.; Li, Z.; Mu, C.; Ma, W.; Hu, H.; Jiang, K.; Lin, H.; Ade, H.; Yan, H. Aggregation and Morphology Control Enables Multiple Cases of High-Efficiency Polymer Solar Cells. Nat. Commun. 2014, 5, 5293.
(16) Vohra, V.; Kawashima, K.; Kakara, T.; Koganezawa, T.; Osaka, I.; Takimiya, K.; Murata, H. Efficient Inverted Polymer Solar Cells Employing Favourable Molecular Orientation. Nat. Photonics 2015, 9, 403-408.
(17) Cheng, S.; Smith, D. M.; Li, C. Y. How Does Nanoscale Crystalline Structure Affect Ion Transport in Solid Polymer Electrolytes? Macromolecules 2014, 47, 3978-3986.
(18) Trigg, E. B.; Gaines, T. W.; Marechal, M.; Moed, D. E.; Rannou, P.; Wagener, K. B.; Stevens, M. J.; Winey, K. I. Self-Assembled Highly Ordered Acid Layers in Precisely Sulfonated Polyethylene Produce Efficient Proton Transport. Nat. Mater. 2018, 17, 725-731.
(19) Croce, F.; Appetecchi, G. B.; Persi, L.; Scrosati, B. Nanocomposite Polymer Electrolytes for Lithium Batteries. Nature 1998, 394, 456-458.
(20) Zhao, Q.; Liu, X. T.; Stalin, S.; Khan, K.; Archer, L. A. Solid-State Polymer Electrolytes with in-Built Fast Interfacial Transport for Secondary Lithium Batteries. Nat. Energy 2019, 4, 365-373.
(21) Hickner, M. A.; Ghassemi, H.; Kim, Y. S.; Einsla, B. R.; McGrath, J. E. Alternative Polymer Systems for Proton Exchange Membranes (Pems). Chem. Rev. 2004, 104, 4587-4611.
(22) Buchholz, V.; Enkelmann, V. Photochemical Single-Crystal-to-Single-Crystal Dimerizations and Polymerizations. Mol. Cryst. Liq. Cryst. Sci. Technol., Sect. A 2001, 356, 315-325.
(23) Yamada, S.; Uematsu, N.; Yamashita, K. Role of Cation-Pi Interactions in the Photodimerization of Trans-4-Styrylpyridines. J. Am. Chem. Soc. 2007, 129, 12100-12101.
(24) Yamada, S.; Tokugawa, Y. Cation-Pi Controlled Solid-State Photodimerization of 4-Azachalcones. J. Am. Chem. Soc. 2009, 131, 2098-2099.
(25) Guo, Q.-H.; Liu, Z. C.; Li, P.; Shen, D. K.; Xu, Y. B.; Ryder, M. R.; Chen, H. Y.; Stern, C. L.; Malliakas, C. D.; Zhang, X.; Zhang, L.; Qiu, Y. Y.; Shi, Y.; Snurr, R. Q.; Philp, D.; Farha, O. K.; Stoddart, J. F. A Hierarchical Nanoporous Diamondoid Superstructure. Chem 2019, 5, 2353-2364.
(26) Metzger, A.; Lynch, V. M.; Anslyn, E. V. A Synthetic Receptor Selective for Citrate. Angew. Chem., Int. Ed. 1997, 36, 862-865.
(27) Wallace, K. J.; Belcher, W. J.; Turner, D. R.; Syed, K. F.; Steed, J. W. Slow Anion Exchange, Conformational Equilibria, and Fluorescent Sensing in Venus Flytrap Aminopyridinium-Based Anion Hosts. J. Am. Chem. Soc. 2003, 125, 9699-9715.
(28) Herrmann, W.; Schneider, M.; Wenz, G. Photochemical Synthesis of Polyrotaxanes from Stilbene Polymers and Cyclodextrins. Angew. Chem., Int. Ed. 1997, 36, 2511-2514.
(29) Jon, S. Y.; Ko, Y. H.; Park, S. H.; Kim, H. J.; Kim, K. A Facile, Stereoselective [2+2] Photoreaction Mediated by Cucurbit[8]Uril. Chem. Commun. 2001, 1938-1939.
(30) Ramamurthy, V.; Sivaguru, J. Supramolecular Photochemistry as a Potential Synthetic Tool: Photocycloaddition. Chem. Rev. 2016, 116, 9914-9993.
(31) Ma, L. L.; An, Y. Y.; Sun, L. Y.; Wang, Y. Y.; Hahn, F. E.; Han, Y. F. Supramolecular Control of Photocycloadditions in Solution: In Situ Stereoselective Synthesis and Release of Cyclobutanes. Angew. Chem., Int. Ed. 2019, 58, 3986-3991.
(32) Amirsakis, D. G.; Garcia-Garibay, M. A.; Rowan, S. J.; Stoddart, J. F.; White, A. J. P.; Williams, D. J. Host-Guest Chemistry Aids and Abets a Stereospecific Photodimerization in the Solid State. Angew. Chem., Int. Ed. 2001, 40, 4256-4261.
(33) Amirsakis, D. G.; Elizarov, A. M.; Garcia-Garibay, M. A.; Glink, P. T.; Stoddart, J. F.; White, A. J. P.; Williams, D. J. Diastereospecific Photochemical Dimerization of a Stilbene-Containing Daisy Chain Monomer in Solution as Well as in the Solid State. Angew. Chem., Int. Ed. 2003, 42, 1126-1132.
(34) MacGillivray, L. R.; Papaefstathiou, G. S.; Friscic, T.; Hamilton, T. D.; Bucar, D. K.; Chu, Q.; Varshney, D. B.; Georgiev, I. G. Supramolecular Control of Reactivity in the Solid State: From Templates to Ladderanes to Metal-Organic Frameworks. Acc. Chem. Res. 2008, 41, 280-291.
(35) Schmidt, G. M. J. Photodimerization in the Solid State. Pure. Appl. Chem. 1971, 27, 647-678.
(36) The mean positions and occupancies of atoms in the partially polymerized structure can be determined by X-ray crystallography from three-dimensional maps of the electron densities.
(37) Since the crystalline polymers are insoluble in common organic solvents, it is not possible to measure their molecular weights and degrees of polymerization using the well-known techniques for characterizing polymers. On the basis of single-crystal structures, the molecular weight (M) and degree of polymerization (DP) per μm are estimated to be 662 kg mol⁻¹ and 685, respectively.
(38) The fact that the photopolymerization cannot be conducted on the amorphous monomer was verified by the observation that there were no notable changes in the ¹H NMR spectrum of the amorphous monomer under UV irridiation for 3 h.
(39) The PXRD peaks were recorded at room temperature after the crystalline monomers had been left outdoors in sunlight for 0, 1, and 3 h. The quality of these PXRD peaks recorded at room temperature was not as good as those obtained after UV irradiation of the crystalline monomers at 100 K. In general, the lower the temperatures at which the PXRD is recorded, the better are the qualities of the PXRD peaks.
(40) Hernandez, Y.; Nicolosi, V.; Lotya, M.; Blighe, F. M.; Sun, Z.; De, S.; McGovern, I. T.; Holland, B.; Byrne, M.; Gun'Ko, Y. K.; Boland, J. J.; Niraj, P.; Duesberg, G.; Krishnamurthy, S.; Goodhue, R.; Hutchison, J.; Scardaci, V.; Ferrari, A. C.; Coleman, J. N. High-Yield Production of Graphene by Liquid-Phase Exfoliation of Graphite. Nat. Nanotechnol. 2008, 3, 563-568.
(41) Kissel, P.; Erni, R.; Schweizer, W. B.; Rossell, M. D.; King, B. T.; Bauer, T.; Gotzinger, S.; Schluter, A. D.; Sakamoto, J. A Two-Dimensional Polymer Prepared by Organic Synthesis. Nat. Chem. 2012, 4, 287-291.
(42) Cohen-Tanugi, D.; Grossman, J. C. Water Desalination across Nanoporous Graphene. Nano Lett. 2012, 12, 3602-3608.
(43) Oliver, W. C.; Pharr, G. M. An Improved Technique for Determining Hardness and Elastic-Modulus Using Load and Displacement Sensing Indentation Experiments. J. Mater. Res. 1992, 7, 1564-1583.
(44) Nanoindentation was performed at room temperature under normal atmospheric pressure. Hardness and Young's moduli were measured on a Hysitron 950 Tribolndenter with a Berkovich indenter (radius 100 nm). The data were analyzed using standard Oliver and Pharr analysis.
(45) Tan, J. C.; Cheetham, A. K. Mechanical Properties of Hybrid Inorganic—Organic Framework Materials: Establishing Fundamental Structure—Property Relationships. Chem. Soc. Rev. 2011, 40, 1059-1080.
(46) The values of Young's modulus for MOFs are usually in the range from 1.5 to 25 GPa. A typical value is 5 GPa. See ref 45.
(47) Jee, A. Y.; Lee, M. Comparative Analysis on the Nanoindentation of Polymers Using Atomic Force Microscopy. Polym. Test. 2010, 29, 95-99.
(48) Kole, G. K.; Kojima, T.; Kawano, M.; Vittal, J. J. Reversible Single-Crystal-to-Single-Crystal Photochemical Formation and Thermal Cleavage of a Cyclobutane Ring. Angew. Chem., Int. Ed. 2014, 53, 2143-2146.
(49) Papagni, A.; Del Buttero, P.; Bertarelli, C.; Miozzo, L.; Moret, M.; Pryce, M. T.; Rizzato, S. Novel Fluorinated Amino-Stilbenes and Their Solid-State Photodimerization. New J. Chem. 2010, 34, 2612-2621.
(50) After soaking the crystalline polymer in various concentrated acids for three months, the chemical composition of the resulting polymer underwent small changes. The BF₄⁻ counterions can be exchanged partially by the anions associated with the acids. Meanwhile, H₂O was adsorbed into the polymer.
(51) Measured in H₂O to D₂O, respectively, the Nyquist plots showed identical shapes, while the conductivities shifted from 3×10⁻⁴ to 1.4×10⁻⁴ S cm⁻¹. Because the mass of deuterium is two times larger than that of proton, the charge mobility or the conductivity of a deuterium, is approximately half that of a proton. This deuterium effect is a solid indication that the crystalline polymeric material is a proton conductor rather than a conductor of other charges.
(52) Rolandi, M. Bioelectronics: A Positive Future for Squid Proteins. Nat. Chem. 2014, 6, 563-564.
(53) Josberger, E. E.; Hassanzadeh, P.; Deng, Y.; Sohn, J.; Rego, M. J.; Amemiya, C. T.; Rolandi, M. Proton Conductivity in Ampullae of Lorenzini Jelly. Sci. Adv. 2016, 2, e1600112.
(54) Selberg, J.; Jia, M.; Rolandi, M. Proton Conductivity of Glycosaminoglycans. PLoS One 2019, 14, e0202713.
(55) Nagle, J. F.; Morowitz, H. J. Molecular Mechanisms for Proton Transport in Membranes. Proc. Natl. Acad. Sci. 1978, 75, 298-302.

### Examples

### General Information

All commercially available reagents were used as received. Anhydrous MeCN was prepared by solvent drying system. Infrared spectra (IR) were recorded using a Nexus 870 spectrometer. Nuclear magnetic resonance (NMR) spectra were recorded on Bruker Avance 500 spectrometers, with working frequencies of 500 MHz for ¹H and 125 MHz for ¹³C nuclei, respectively. Chemical shifts were reported in ppm relative to the signals corresponding to the residual non-deuterated solvents (CD₃CN: δ_{H}=1.94 and δ_{C}=118.3 ppm). Abbreviations are used in the description of NMR data as follows: chemical shift (6, ppm), multiplicity (s=singlet, d=doublet), coupling constant (J, Hz). High-resolution mass spectra (ESI-HRMS) were measured on a Finnigan LCQ iontrap mass spectrometer. Single-crystal X-ray diffraction (SCXRD) data were collected on a Bruker APEX-II CCD diffractometer. Powder X-ray diffraction (PXRD) patterns were measured on an STOE-STADIMP powder diffractometer (Cu-Kα₁ radiation, λ=1.54056 Å). Scanning electron microscopy (SEM) images were collected on a Hitachi SU8030 SEM. Transmission electron microscopy (TEM) images were performed on a JEOL ARM300F GrandARM. Thermogravimetric analyses (TGA) and differential scanning calorimetry (DSC) were performed on a TGA/DCS 1 system. Solid-state cross-polarization magic angle spinning (CPMAS) ¹³C NMR spectroscopy was recorded on a 400 MHz Bruker Avance III HD system. Atomic force microscopy (AFM) was performed on a SPID Bruker FastScan AFM. Nanoindentation was performed on a Hysitron 950 Tribolndenter. Chanzon High Power Led Chips (UV 365 nm/900 mA/DC 9V-11V/10 W) were used for the irradiation experiments. Xenon Light Source 300 W Monochromatic Light (MAX 350) with a 254 nm filter to study depolymerizations.

### Methods

Photopolymerization for in-situ single-crystal X-ray diffractometer: One single crystal of monomer 1•3BF₄ was selected, and a full set of diffraction data was collected in order to determine the structure. This crystal was irradiated—a 10 W, 365 nm LED, about 1.5 cm from the crystal—directly on the goniometer pin at 100 K for 3 h and another set of data collection afforded the structure of intermediate. Then, the same crystal was irradiated for another 6 h at 100 K in order to afford the final polymer.

Gram-scale photopolymerizations: One gram of monomer crystals was obtained from a 1:10 mixture of MeCN and iPr₂O. The freshly prepared crystals were suspended in the mother liquor and kept in a 30-mL glass vial. The vial was placed closely under an LED. The crystals were irradiated with a 365-nm LED light for 9 h. The vial was shaken gently every hour in order to make sure the crystals were being irradiated homogeneously. The whole procedure was carried out in a fume hood. Polymerizations were monitored by ¹H NMR spectroscopy, IR and CPMAS ¹³C NMR spectroscopies further identified the final products. The yield was calculated using the equation, Y=Mp/Mm×100%, where Y is the yield, Mp is the weight of the single-crystalline polymer, and Mm is the weight of the monomer.

Computational electronic and mechanical properties: Density functional theory (DFT) was used to calculate the electronic properties of the polymer using the B3LYP-D3 functional and all-electron basis sets similar to our previous work on supramolecular and framework materials^{49,25}. The electronic band gap of the ionic polymer crystal is predicted to be 3.72 eV. The anisotropic Young's moduli of the polymer were computed using a composite method (HF-3C), and the 3D representation is provided in FIG. 17.

Proton conductivities: Crystalline polymers were crushed into powders and drop-cast (FIG. 27) on the two-terminal devices. Alternating current (a.c.) potentials were applied to the polymer hydrated at different relative humidities. The Nyquist plots were matched with a simple equivalent. The Constant Phase Element (CPE) was used to describe the non-ideal capacitive effect of the interface between the material and contacts. We also measured the proton conductivity of Nafion using the same device: it was ˜0.1 S cm⁻¹.

### Synthesis of Monomer

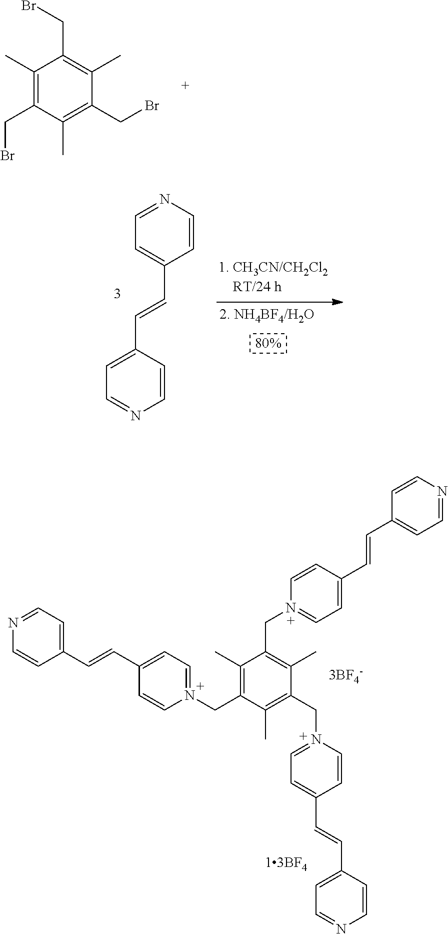

### Scheme 1. Synthesis of 1.3BF₄

1•3BF₄: A solution of 1,3,5-tris(bromomethyl)-2,4,6-trimethylbenzene (800 mg, 3 mmol) in dry CH₂Cl₂ (20 mL) and MeCN (5 mL) was added dropwise during 12 h by syringe to a solution of (E)-1,2-di(pyridin-4-yl)ethene (8.20 g, 45 mmol) in anhydrous CH₂Cl₂ (30 mL) and MeCN (60 mL) under an N₂ atmosphere. The flask was wrapped with aluminium foil and the mixture was stirred continuously for 24 h at room temperature. The resulting white precipitate was collected by filtration, washed with CH₂Cl₂ (3×50 mL) and MeCN (3×50 mL), and dried. The precipitate was dissolved in H₂O (1.5 L). A solution of NH₄BF₄ (6.0 g) in H₂O (20 mL) was added to the above-mentioned solution of the monomer. The resulting white precipitate was collected by filtration, washed with H₂O (3×50 mL), and dried. The remaining solid was recrystallized from MeCN and iPr₂O to afford 1•3BF₄ as a colorless crystalline solid (2.32 g, 2.4 mmol) in 80% yield. ¹H NMR (500 MHz, CD₃CN, 298 K) δ_{H}=8.68 (d, J=6.1 Hz, 12H), 8.51 (d, J=6.9 Hz, 12H), 8.13 (d, J=7.0 Hz, 12H), 7.76 (d, J=16.5 Hz, 12H), 7.62-7.55 (m, 18H), 5.87 (s, 12H), 2.27 (s, 18H); ¹³C NMR (125 MHz, CD₃CN, 298 K) δ_{C}=17.2, 58.9, 122.3, 125.9, 127.6, 129.3, 139.4, 142.6, 144.0, 144.8, 151.3, 153.9; ESI-HRMS Calcd for C₄₈H₄₅F₁₂B₃N₆: m/z=879.3759 [M-BF₄]⁺, 396.1862 [M-2BF₄]²⁺; found: 879.3772 [M-BF₄]⁺, 396.1874 [M-2BF₄]²⁺.

### X-Ray Crystallographic Characterization

Single crystals of 1•3BF₄ were obtained after only one day by slow vapor diffusion of iPr₂O into a MeCN solution. In order to monitor the polymerization by in-situ single-crystal X-ray diffractometer, one single crystal was selected and mounted in inert oil and transferred to the cold N₂ gas stream of a Bruker Kappa APEX CCD area detector diffractometer. The crystal was kept at 100 K during the data collection. After a set of data collection was finished, the same crystal was irradiated directly on the diffractometer under 100 K for 3 h to afford the intermediate crystal. This crystal was kept at 100 K during the data collection. After this set of data collection was finished, the same crystal was irradiated for another 6 h under 100 K to afford the final polymeric crystal. This crystal was kept at 100 K for the data collection. Even though, as the polymerization proceeded, the quality of the single crystal decreased. Both the single-crystal structures of the intermediate and the polymer, however, could be solved. Considering that we are dealing with a challenging single-crystal-to-single-crystal polymerization, it should be acceptable that the quality of polymer crystal cannot compete with the standard compounds, which are obtained by well-known procedures. Using Olex2⁵, the above data were resolved with the ShelXT⁶ structure solution program and all the structures (the monomer, the intermediate and the final polymer) were refined with the ShelXL⁷ package using least-squares minimization.

The crystallographic information, structural parameters for 1•3BF₄ monomer, intermediate crystal, and 2•nPF6 polymer are as follows.

1•3BF₄ Monomer Crystal Data for C₄₈H_{47.67}B₃F₁₂N₆O_{1.33} (M=990.35 g/mol): monoclinic, space group C12/c1 (no. 15), a=58.143(2), b=11.9245(5), c=15.4738(7) A, α=90, β=102.308(3), γ=90°, V=10481.8(8) Å³, Z=8, T=100.02 K, μ(Cu Kα)=0.908 mm⁻¹, Dcalc=1.255 g/cm³. The final R₁ was 0.1079 (I>2σ(I)) and wR₂ was 0.3034 (all data).

Intermediate Crystal Data for C₉₆H₉₀B₆F₂₄N₁₂O₃ (M=1980.65 g/mol): monoclinic, space group C12/c1 (no. 15), a=90, β=103.731(2), γ=90°, V=10526.6(5) Å³, Z=4, T=100 K, μ(Cu Kα)=0.907 mm⁻¹, Dcalc=1.250 g/cm³. The final R₁ was 0.1469 (I>2σ(I)) and wR₂ was 0.4541 (all data).

2•nBF₄ Polymer Crystal Data for C₄₈H₄₅B₃F₁₂N₆O₁ (M=982.33 g/mol): monoclinic, space group C12/c1 (no. 15), a=57.282(7), b=11.7334(15), c=16.2714(18) Å, α=90, β=104.674(7), γ=90°, V=10579.5(5) Å³, Z=8, T=102(2) K, μ(Cu Kα)=0.891 mm⁻¹, Dcalc=1.233 g/cm³. The final R₁ was 0.1698 (I>2σ(I)) and wR₂ was 0.4877 (all data).

TABLE 1
Parameters of single crystals of monomer, intermediate and polymer.

| | Space | α | β | γ | a | b | c | V | Change of |
|---|---|---|---|---|---|---|---|---|---|
| | Group | (°) | (°) | (°) | (Å) | (Å) | (Å) | (Å³) | V/% |
| Monomer | C2/c | 90 | 102.31 | 90 | 58.14 | 11.92 | 15.47 | 10481.8 | — |
| Intermediate | C2/c | 90 | 103.73 | 90 | 57.90 | 11.88 | 15.75 | 10526.6 | +0.43 |
| Polymer | C2/c | 90 | 104.67 | 90 | 57.28 | 11.73 | 16.27 | 10579.5 | +0.93 |

### Sunlight-Triggered Photopolymerization

Freshly prepared crystals were suspended in their mother liquor and kept in a 3-mL quartz cuvette. The cuvette was sealed and placed on the garden under the sunlight at Northwestern University, Evanston. The crystals were irradiated from 10 am to 4 pm on July 23 and 24, 2019 (6 hours per day). The cuvette was shaken gently every hour in order to make sure the crystals were irradiated homogeneously. Four 6-mg aliquots of crystals were taken out at different time intervals (1, 3, 6, and 9 h) and dissolved in CD₃CN for ¹H NMR spectroscopy and PXRD. The final product was also identified by 41 NMR spectroscopy and PXRD.

### Gram-Scale Photopolymerization

One gram of monomer crystals were grown in the mixture of MeCN and iPr₂O (1:10). The freshly prepared crystals were suspended in their mother liquor and kept in a 30-mL glass vial. The vial was placed closely under the LED, which was connected with a cooling fan. The crystals were irradiated with 365 nm light for 9 h at room temperature. The vial was shaken gently every hour in order to make sure the crystals were irradiated homogeneously. Seven 3-mg aliquots of crystals were taken out at different time intervals (0.25, 0.5, 1, 3, 6, and 9 h) and dissolved in CD₃CN for recording ¹H NMR spectra. The final product was also identified by CPMAS ¹³C NMR spectroscopy and IR spectrophotometry.

### Transmission Electron Microscopy (TEM)

In order to prepare samples with appropriate sizes for (HR)TEM imaging, the polymeric crystals were partially exfoliated. The crystals were stirred at room temperature for 1 h and sonicated for 30 min in MeCN. Then, they were deposited on a Cu grid.

### Nanoindentation

Hardness and Young's moduli were measured on a Hysitron 950 Tribolndenter with a Berkovich indenter (radius 100 nm). A large single crystal of monomer 1•3BF₄ was first mounted onto stainless steel atomic force microscopy specimen disks by epoxy (J-B Kwik) with the (001) plane facing up. For all measurements, the loading and unloading rate were kept at about 50 μN/s and before unloading, the indenter was held at constant load (500 μN) for 10 s. The same crystal was checked before and after polymerization. The data were analyzed using standard Oliver and Pharr analysis to extract the reduced moduli and hardness. The out-of-plane Young's moduli of the materials can be further derived with a Young's modulus E of 1141 GPa and Poisson's ratio v of 0.07 for the diamond tip and v=0.3 for monomer and polymer crystals. For each type of sample, two crystals were prepared and 17 indentations were performed on each crystal. The reported values for each type of sample were averaged by all 34 measurements.

### DFT Calculations and Response Properties

The anisotropic single-crystal properties of the ionic polymer crystal were computed using first-principles density functional theory (DFT) calculations performed using the periodic CRYSTAL17 code⁸. The B3LYP hybrid exchange-correlation functional⁹⁻¹¹ was used with a semiempirical dispersion correction accounting for two-body and three-body contributions (B3LYP-D3)¹², and the geometry optimization was compared with another commonly used DFT functional, PBE-D3¹²⁻¹⁴. Each DFT calculation was performed with all-electron atom-centered Gaussian-type basis sets of double-zeta quality, similar to previous work on the dielectric and electronic properties of other supramolecular and framework materials^{15,16}. The crystalline orbitals were considered as linear combinations of Bloch functions (BF) and evaluated using a regular three-dimensional (3D) mesh in reciprocal space. Each BF was constructed from local atomic orbitals (AOs), consisting of linear combinations of Gaussian-type functions (GTF). The all-electron basis sets contained a total of 9,528 basis functions, corresponding to 3,984 electrons spread over 3,384 shells per unit cell for the polymer crystal.

Due to the structural disorder of the anions present in the experimentally obtained CIF, the symmetry was reduced in the geometry optimization to allow for the lowest energy ordered structure to be obtained. The geometry optimization resulted in symmetry reduction from the C2/c (15) to P2/c (13) space group. The lattice parameters and atomic coordinates of the ionic polymer crystal were optimized, while maintaining the P2/c (13) space group symmetry. The optimization was considered to have converged when the maximum and root-mean-square (RMS) gradient, and the maximum and RMS atomic displacements were simultaneously below 4.5×10⁻⁴, 3.0×10⁻⁴, 1.8×10⁻³ and 1.2×10⁻³ a.u., respectively.

The static dielectric constant and refractive index of the ionic polymer crystal were calculated analytically via a Coupled-Perturbed Hartree-Fock/Kohn-Sham (CPHF/CPKS) approach with the B3LYP-D3 functional. The CPHF/CPKS approach involved calculating the polarizability and dielectric tensors, as reported in Ref.15. The electronic band gap of the ionic polymer crystal is predicted to be 3.72 eV using the B3LYP-D3 functional, and the values of the other anisotropic properties are summarized in Table 2.

For the calculation of the anisotropic Young's moduli of the ionic polymer crystal, reported in Table 3 and FIG. 17, the methodology reported in Ref 17 was used with a minimal basis Hartree-Fock (HF) composite method (HF-3C) instead of DFT¹⁸. The method was designed to compete with semi-empirical tight-binding approaches without neglecting many-center integrals and has been tested using the CRYSTAL17 code¹⁸. It is worth noting that the HF-3C results reported here are limited to Young's moduli and a full analysis of the anisotropic mechanical properties and stability will be reported in a follow-on study.

Summarized in Table 2 are the comparisons of the optimized lattice parameters calculated from DFT and HF-3C (for ideal crystalline structures) with the experimental values.

TABLE 2
Comparison of the lattice parameters for the polymer crystal.
Polycationic Polymer Crystal

| | Lattice parameters (Å) | | | |
|---|---|---|---|---|
| Method | a | b | c | β |
| Experimental CIF | 57.282(7) | 11.7334(15) | 16.2714(18) | 104.674(7) |
| B3LYP-D3 | 57.98 | 11.05 | 16.40 | 105.0 |
| PBE-D3 | 58.23 | 11.13 | 16.50 | 104.9 |
| HF3C | 57.82 | 10.95 | 16.51 | 102.9 |

The average difference compared to the experimental parametersfor B3LYP-D3: 2.05%
The average difference compared to the experimental parametersfor PBE-D3: 2.11%
The average difference compared to the experimental parametersfor HF3C: 2.69%

TABLE 3
Summary of the anisotropic properties of the polycationic polymer crystal

| | Crystallographic axis | | |
|---|---|---|---|
| | a | b | c |
| Dielectric tensor, k | 1.92 | 2.04 | 2.45 |
| Refractive index, n | 1.39 | 1.43 | 1.57 |

### Proton Conductivity

Samples were mechanically ground into sufficiently small particle sizes. Impedance data were recorded by Autolab PGSTAT128N between 100 kHz and 0.1 Hz at 20 mV amplitude, and analysized by Nova 2.0 software. A simple equivalent circuit was used here to simulate the Nyquist plots. Experiments were carried out in a home-made humidity control chamber with N₂ atmosphere. Before each measurement, the sample was incubated for 2 h at different humidities to reach a stable status.

The two-terminal devices used in EIS measurements were fabricated on glass. Prior to device fabrication, the substrates were cleaned by sequential sonication in Me₂CO and iPrOH. Then, a 10 nm Titanium adhesion layer overlaid with a 100 nm gold was electron-beam evaporated onto the clean substrates through a shadow mask. The dimensions of the paired electrodes were 2.5 cm wide by 2.0 cm long with an inter-electrode separation of 50 μm. The devices were completed by dropping cast the bulk polymer powders suspended in MeCN solution directly onto the electrode patterns, and the resulting films were allowed to dry in air overnight.

A Constant Phase Element (CPE) was used to describe the non-ideal interface capacitance, R_{b} and C_{b} represent the resistance and capacitance of the sample, respectively. (FIG. 25)

The conductivity (σ) of the sample is calculated with the equation below:

σ=L/R_{b}A

where S and L are the cross-sectional area and thickness of the sample, respectively, and R_{b} is the value of resistance, which was obtained from the impedance plots.

Molecular dynamics (MD) simulations of water structure were conducted using the RASPA software package¹⁹. The unit cell from the experimental crystal structure was expanded to a 1×3×2 super-cell as the simulation box to satisfy the minimum image convention. In 6 different simulations, 10, 20, 30, 40, 50, or 60 water molecules per unit cell were added to the box by configuration-biased Monte Carlo insertions²⁰ prior to the MD simulations. Then, 100 ps of MD in the canonical (NVT) ensemble at 298 K were conducted in each simulation in which the water molecules were allowed to move while the polymer and the counterions were held fixed. In all simulations, the Lennard-Jones parameters for the polymer and counterions were taken from the DREIDING force field²¹, while the water molecules were described by the TIP4P model²². The partial charges of the polymer and counterion atoms were derived using the QEq method²³. The long-range van der Waals interactions were truncated at 12.8 Å with analytical tail corrections, while the long-range electrostatics were calculated using the Ewald summation.

TABLE 4
Comparison of proton conductivities of 2 · nBF₄ with those of COFs.

| | Proton | Relative Humidity | |
|---|---|---|---|
| | conductivity | (RH)/Temperature | |
| Material | (S cm⁻¹) | (° C.) | Reference |
| 2 · nBF4 | 2.6 × 10 ⁻⁴ | 90%/25 | This work |
| Nafion | 1 × 10 ⁻¹ | 90%/25 | This work |
| NUS-10 (R) | 3.96 × 10 ⁻² | 97%/25 | ACS Appl. Mater. |
| | | | Interfaces. 2016, 8, |
| | | | 18505. |
| LiCl@RT- | 6.45 × 10 ⁻³ | 100%/40 | J. Am. Chem. Soc. |
| COF-1 | | | 2017, 139, 10079. |
| EB-COF:PW₁₂ | 3.32 × 10 ⁻³ | 97%/25 | J. Am. Chem. Soc. |
| | | | 2016, 138, 5897. |
| PA@TP-Azo | 9.9 × 10 ⁻⁴ | 98%/60 | J. Am. Chem. Soc. |
| | | | 2014, 136, 6570. |
| RT-COF-1AcB | 5.25 × 10 ⁻⁴ | 100%/40 | Nat. Commun. 2015, |
| | | | 6, 6486. |
| RT-COF-1AC | 1.07 × 10 ⁻⁴ | 100%/40 | J. Am. Chem. Soc. |
| | | | 2017, 139, 10079. |
| PA@TP-Stb | 2.3 × 10 ⁻⁵ | 98%/60 | J. Am. Chem. Soc. |
| | | | 2014, 136, 6570. |
| RT-COF-1 | 1.83 × 10 ⁻⁵ | 100%/40 | J. Am. Chem. Soc. |
| | | | 2017, 139, 10079. |
| aza-COF-2 | 8.78 × 10 ⁻⁶ | 97%/50 | Chem. Mater. 2019, |
| | | | 31, 819. |
| EB-COF:Br | 2.82 × 10 ⁻⁶ | 97%/25 | J. Am. Chem. Soc. |
| | | | 2016, 138, 5897. |
| PA@TpBpy- | 2.5 × 10 ⁻³ | 0%/100 | J. Mater. Chem. A |
| MC | | | 2016, 4, 2682. |
| im@TPB- | 1.79 × 10 ⁻³ | 0%/125 | Nat. Mater. 2016, 15, |
| DMTPCOF | | | 722. |
| Phytic@TpPa- | 5 × 10 ⁻⁴ | 0%/120 | Chem. Mater. 2016, |
| (SO3H-Py) | | | 28, 1489. |
| TpPa-SO₃H | 1.7 × 10⁻⁵ | 0%/120 | Chem. Mater. 2016, |
| | | | 28, 1489. |

### REFERENCES IN THE EXAMPLES

1. E. R. Johnson, S. Keinan, P. Mori-Sanchez, J. Contreras-Garcia, A. J. Cohen, W. Yang, Revealing noncovalent interactions. J Am Chem Soc 132, 6498-6506 (2010).
2. Gaussian 16, Revision B.01, M. J. Frisch, G. W. Trucks, H. B. Schlegel, G. E. Scuseria, M. A. Robb, J. R. Cheeseman, G. Scalmani, V. Barone, G. A. Petersson, H. Nakatsuji, X. Li, M. Caricato, A. V. Marenich, J. Bloino, B. G. Janesko, R. Gomperts, B. Mennucci, H. P. Hratchian, J. V. Ortiz, A., F. Izmaylov, J. L. Sonnenberg, D. Williams-Young, F. Ding, F. Lipparini, F. Egidi, J. Goings, B. Peng, A. Petrone, T. Henderson, D. Ranasinghe, V., G. Zakrzewski, J. Gao, N. Rega, G. Zheng, W. Liang, M. Hada, M. Ehara, K. Toyota, R. Fukuda, J. Hasegawa, M. Ishida, T. Nakajima, Y. Honda, O. Kitao, H. Nakai, T. Vreven, K. Throssell, J. A. Montgomery, Jr., J. E. Peralta, F. Ogliaro, M. J. Bearpark, J. J. Heyd, E. N. Brothers, K. N. Kudin, V. N. Staroverov, T. A. Keith, R. Kobayashi, J. Normand, K. Raghavachari, A. P. Rendell, J. C. Burant, S. S. Iyengar, J. Tomasi, M. Cossi, J. M. Millam, M. Klene, C. Adamo, R. Cammi, J. W. Ochterski, R. L. Martin, K. Morokuma, O. Farkas, J. B. Foresman, and D. J. Fox, Gaussian, Inc., Wallingford Conn., 2016.
3. H. S. Yu, X. He, S. L. Li, D. G. Truhlar, MN15: A Kohn-Sham global-hybrid exchange-correlation density functional with broad accuracy for multi-reference and single-reference systems and noncovalent interactions. Chem Sci 7, 5032-5051 (2016).
4. F. Weigend, R. Ahlrichs, Balanced basis sets of split valence, triple zeta valence and quadruple zeta valence quality for H to Rn: Design and assessment of accuracy. Phys Chem Chem Phys 7, 3297-3305 (2005).
5. O. V. Dolomanov, L. J. Bourhis, R. J. Gildea, J. A. Howard, H. Puschmann, OLEX2: A complete structure solution, refinement and analysis program. J. Appl. Cryst. 42, 339-341 (2009).
6. G. Sheldrick, SHELXT-Integrated space-group and crystal-structure determination. Acta Cryst. 71, 3-8 (2015).
7. G. Sheldrick, A short history of SHELX Acta Cryst. 64, 112-122 (2008).
8. R. Dovesi et al., Quantum-mechanical condensed matter simulations with CRYSTAL. Wires Comput Mot Sci 8, e1360 (2018).
9. A. D. Becke, Density-functional thermochemistry. III. The role of exact exchange. J. Chem. Phys. 98, 5648-5652 (1993).
10. P. J. Stephens, F. J. Devlin, C. F. Chabalowski, M. J. Frisch, Ab initio calculation of vibrational absorption and circular dichroism spectra using density functional force fields. J. Phys. Chem. 98, 11623-11627 (1994).
11. C. T. Lee, W. T. Yang, R. G. Parr, Development of the Colle-Salvetti correlation-energy formula into a functional of the electron density. Phys. Rev. B 37, 785-789 (1988).
12. S. Grimme, J. Antony, S. Ehrlich, H. Krieg, A consistent and accurate ab initio parametrization of density functional dispersion correction (DFT-D) for the 94 elements H-Pu. J. Chem. Phys. 132, 154104 (2010).
13. J. P. Perdew, K. Burke, M. Ernzerhof, Generalized gradient approximation made simple. Phys. Rev. Lett. 77, 3865-3868 (1996).
14. S. Grimme, J. Antony, S. Ehrlich, H. Krieg, A consistent and accurate ab initio parametrization of density functional dispersion correction (DFT-D) for the 94 elements H-Pu. J. Chem. Phys. 132, 154104 (2010).
15. M. R. Ryder, L. Dona, J. G. Vitillo, B. Civalleri, Understanding and controlling the dielectric response of metal—organic frameworks. ChemPlusChem 83, 308-316 (2018).
16. Q.-H. Guo, Z. Liu, P. Li, D. Shen, Y. Xu, M. R. Ryder, H. Chen, C. L. Stern, C. D. Malliakas, X. Zhang, et al., A hierarchical nanoporous diamondoid superstructure. Chem 5, 2353-2364 (2019).
17. M. Ryder, Physical phenomena in metal-organic frameworks: mechanical, vibrational, and dielectric response. University of Oxford (2017).
18. M. Cutini, B. Civalleri, M. Corno, R. Orlando, J. G. Brandenburg, L. Maschio, and P. Ugliengoa. J. Chem. Theory Comput. 12, 3340-3352 (2016).
19. D. Dubbeldam, S. Calero, D. E. Ellis, R. Q Snurr, RASPA: Molecular simulation software for adsorption and diffusion in flexible nanoporous materials. Mol. Simul., 42, 81-101 (2016).
20. J. Ilja Siepmann, D. Frenkel, Configurational bias monte carlo: A new sampling scheme for flexible chains. Mol. Phy., 75, 59-70 (1992).
21. S. L. Mayo, B. D. Olafson, W. A. Goddard III, DREIDING: A generic force field for molecular simulations. J. Phy. Chem., 94, 8897-8909 (1990).
22. W. L. Jorgensen, J. Chandrasekhar, J. D. Madura, R. W. Impey, M. L. Klein, Comparison of simple potential functions for simulating liquid water. J. Chem. Phy., 79, 926 (1983).
23. A. K. Rappé, W. A. Goddard III, Charge equilibration for molecular dynamics simulations. J. Phy. Chem., 95, 3358-3363 (1991).

We claim:

1. A supramolecular composition comprising an ordered arrangement of an organic ion and a counterion,
wherein the organic ion comprises a molecular hub, a first polymerizable arm and a second polymerizable arm, and
wherein the organic ion has self-complementary interactions with a first neighboring organic ion and a second neighboring organic anion that allows for the first polymerizable arm within the ordered arrangement to be positioned to react with a polymerizable arm of the first neighboring organic ion and for the second polymerizable arm within the ordered arrangement to be positioned to react with a polymerizable arm of the second neighboring organic ion.

2. The composition of claim 1, wherein each of the first polymerizable arm and the second polymerizable arm comprise, in order extending from the molecular hub, a strain-releasing group, a charge-bearing aryl, a polymerizable moiety, and a aryl.

3. The composition of claim 2, wherein the arms are bipyridinyl arms having the polymerizable moiety interposed between the pyrindinyl rings or styrylpyrindinyl arms having the polymerizable moiety interposed between a pyrindinyl ring and a phenyl ring.

4. The composition of claim 2, wherein the polymerizable moiety is an ethylene moiety, an acetylene moiety, or a diacetylene moiety.

5. The composition of claim 4, wherein the organic ion is

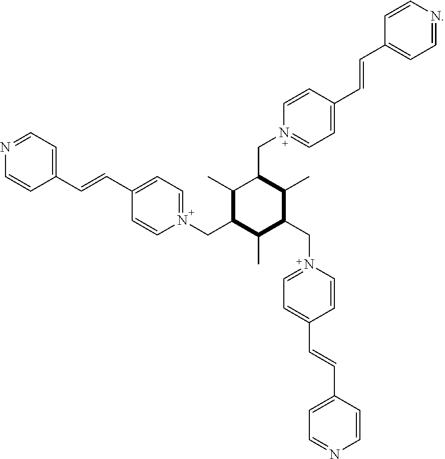

6. The composition of claim 2, wherein the strain-releasing group is a C₁-C₃ alkylene.

7. The composition of claim 2, wherein the molecular hub is a benzene ring,

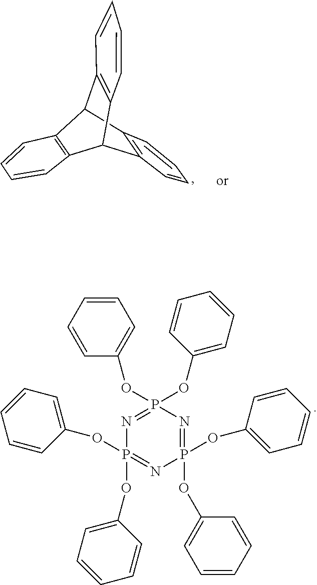

8. The composition of claim 1, wherein the counterion is BF₄⁻, PF₆⁻, AsF₆⁻, Br⁻, or Cl⁻.

9. The composition of claim 1, wherein the organic ion is tricationic.

10. The composition of claim 1, wherein the first polymerizable arm of the organic anion and the second polymerizable arm of the organic ion are aligned anti-parallel to the polymerizable arm of the first neighboring organic ion and the polymerizable arm of the second neighboring organic ion.

11. The composition of claim 1, wherein the organic ions of the ordered arrangement form extended chains.

12. A polyelectrolyte polymer molecule comprising a chain formed from the polymerization of a plurality of organic ions within an ordered arrangement,
wherein each of the organic ions comprise a molecular hub, a first polymerizable arm and a second polymerizable arm and
wherein each of the plurality of organic ions within the ordered arrangement have self-complementary interactions with a first neighboring organic ion and a second neighboring organic anion that allows for the first polymerizable arm within the ordered arrangement to be positioned to react with a polymerizable arm of the first neighboring organic ion and for the second polymerizable arm within the ordered arrangement to be positioned to react with a polymerizable arm of the second neighboring organic ion.

13. The polymer of claim 12, wherein the polyelectrolyte polymer molecule is formed via cyclopolymerization.

14. The poly electrolyte polymer molecule of claim 12, wherein the polyelectrolyte polymer molecule is prepared from a supramolecular composition comprising an ordered arrangement of an organic ion and a counterion,
wherein the organic ion comprises a molecular hub, a first polymerizable arm and a second polymerizable arm, and
wherein the organic ion has self-complementary interactions with a first neighboring organic ion and a second neighboring organic anion that allows for the first polymerizable arm within the ordered arrangement to be positioned to react with a polymerizable arm of the first neighboring organic ion and for the second polymerizable arm within the ordered arrangement to be positioned to react with a polymerizable arm of the second neighboring organic ion.

15. A polyelectrolyte crystal comprising a plurality of the polyelectrolyte polymer molecules according to claim 12 and further comprising a plurality of counterions.

16. The polyelectrolyte crystal of claim 15, wherein the polyelectrolyte crystal is proton conductive.

17. The polyelectrolyte crystal of claim 15, wherein the poly electrolyte crystal comprises channels.

18. The polyelectrolyte crystal of claim 17 further comprising water within the channels.

19. The polyelectrolyte crystal of claim 15,
wherein the poly electrolyte crystal is prepared from a supramolecular composition comprising an ordered arrangement of an organic ion and a counterion,
wherein the organic ion comprises a molecular hub, a first polymerizable arm and a second polymerizable arm,
wherein the organic ion has self-complementary interactions with a first neighboring organic ion and a second neighboring organic anion that allows for the first polymerizable arm within the ordered arrangement to be positioned to react with a polymerizable arm of the first neighboring organic ion and for the second polymerizable within the ordered arrangement to be positioned to react with a polymerizable arm of the second neighboring organic ion.

20. A method of preparing a polyelectrolyte polymer or a poly electrolyte crystal, the method comprising providing the composition of claim 1, irradiating the composition for an effective time with an effective frequency to induce polymerization moiety, thereby forming the polyelectrolyte polymer or the polyelectrolyte crystal.

21. The method of claim 20, wherein the polymerization is a topochemical polymerization.

22. (canceled)
